(19) United States
(12) Patent Application Publication
(10) Pub. No.: US 2011/0093209 A1
(43) Pub. Date: Apr. 21, 2011

(54) METHODS AND SYSTEMS FOR SIMULTANEOUS ALLELIC CONTRAST AND COPY NUMBER ASSOCIATION IN GENOME-WIDE ASSOCIATION STUDIES

(76) Inventors: Wendell Jones, Cary, NC (US); Joel Parker, Apex, NC (US)

(21) Appl. No.: 12/990,184

(22) PCT Filed: Apr. 29, 2009
(86) PCT No.: PCT/US09/41943

§ 371 Date: Dec. 9, 2010

Related U.S. Application Data
(60) Provisional application No. 61/048,322, filed on Apr. 28, 2008.

(51) Int. Cl. G06F 17/18; G06F 19/00

(52) U.S. Cl. 702/19; 702/179

(57) ABSTRACT

Methods and systems are provided for performing allelic copy number association in genome-wide association studies. Also provided are computer-readable media for storing instructions for performing the genomic marker association studies. The methods include performing genomic marker association studies wherein allelic contrast and copy number are analyzed simultaneously, comprising the steps of receiving measurements of intensity for each of two alleles (A and B) in a biological sample set; computing a sum value (S) and a difference value (D) of the intensities; and employing a statistical model to determine a potential association of the S and/or the D value with an outcome, wherein a statistically significant coefficient of the S intensity indicates an association of the copy number with the outcome and a statistically significant coefficient of the D intensity indicates an association of the allelic contrast with the outcome.

### RELATED APPLICATIONS

This application claims priority to U.S. Provisional Patent Application No. 61/048,322, filed Apr. 28, 2008, the entire contents of which are hereby incorporated by reference.

### TECHNICAL FIELD

The presently disclosed subject matter relates to methods and systems for simultaneous allelic contrast and copy number association in genome-wide association studies. Also provided are computer-readable media for storing instructions for performing the genomic marker association studies.

### BACKGROUND

Genome-wide association studies (GWAS) have been used to discover genetic factors that contribute to the development, progression, and treatment of diseases and disorders, such as high blood pressure or obesity. GWAS are particularly useful for the study of common, complex diseases, such as asthma, cancer, diabetes, heart disease and mental illnesses, where the individual genetic contributions to the disease are expected to be relatively weak. GWAS have been made possible as a result of developments in new technologies that can quickly and accurately analyze whole-genome samples, such as for the presence of single nucleotide polymorphisms (SNPs).

The raw measurements used in GWAS are estimates of the frequency of occurrence of a particular sequence in the genome. The genomic sequences being quantified generally include one or more positions or markers in the genome that are thought to be variable in the population. Typically, these markers are SNPs and a specific instance of a marker is termed an allele. The relative frequency of any two alleles (arbitrarily labeled A and B) at the same genetic location is transformed into a genotype for that sample. The combination of two alleles (A and/or B) allowed for three genotypic states associated with each genetic locus is as follows: AA, AB or BB (see FIG. 1). The order of the allele pairs in the AB pair does not matter, only the presence. That is, AB=BA. Current methods employ this three-state model and a corresponding assumption that the genome contains normal copy number (two instances of every marker) in order to assign one of the three possible genotypes to each genomic location. This is referred to as genotype calling. The genotypes are then tested for a probability of association with a given phenotype.

In addition, recent studies have focused on determining genomic regions of total copy number for individuals independent of phenotype (Wang et al., 2007). This is typically performed in one of two ways. First, the ratios of measurement intensities for the Aᵢ and Bᵢ alleles are calculated for each locus i. The modality of the distribution can be inferred over a region of the genome. The modality is directly tied to the genomic copy number for that region. A second method of copy number estimation relates the total marker counts in a region of the genome to the genome wide total marker counts. Copy number changes are then inferred when the regional distribution shifts from the overall distribution of total marker frequency.

The motivation to obtain an accurate estimate of copy number is due to an increasing number of studies that report copy number variation, combined with knowledge of an association of an allele with a particular disease or disorder. However, current methods for determining genotypes and copy number are each limited by the categorization of the data into a small number of discrete genotypes or copy number states. This process results in information loss for markers that fall near the boundaries of these states and is also weakened by potentially unnecessary assumptions (i.e. three-state model of genotypes). Therefore, data are frequently put in a form that is suboptimal for discovery where the data might have otherwise provided an indication of an association with a disease or disorder phenotype. For example, a cluster graph generated using mock data to represent estimated genotypes AA, AB and BB for two independent genetic markers illustrates two problems with the current approach. In the graph shown in FIG. 2b, there is potential overlap between the BB and AB cluster groups, leading to the potential for incorrect assignment of genotypic class (classification error) prior to association with phenotype. Also, there are several points that appear distinct from the large clusters and their nature is unclear for classification purposes. In addition, GWAS study data are frequently used in distinct analyses of genotype and copy number that are in some sense contradictory as, for example, a complete analysis of copy number must not assume the three-state model of genotype.

In contrast, the presently disclosed subject matter provides methods and systems for performing simultaneous allelic contrast and copy number association in genome-wide association studies while requiring fewer and less stringent sets of assumptions. Also provided are computer-readable media for storing instructions for performing the genomic marker association studies.

### SUMMARY

This Summary lists several embodiments of the presently disclosed subject matter, and in many cases lists variations and permutations of these embodiments. This Summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently disclosed subject matter, whether listed in this Summary or not. To avoid excessive repetition, this Summary does not list or suggest all possible combinations of such features.

In some embodiments of the presently disclosed subject matter, a method is provided for performing genomic marker association studies wherein allelic contrast and copy number are analyzed simultaneously, the method comprising: receiving, for each marker, one or more measurements of intensity for each of two alleles (A and B) for each sample in a biological sample set; computing, for each marker, a sum value (S) and a difference value (D) of the intensities. By way of a non-limiting example, an S value can be a sum of the intensities for the two alleles or a transformation of a sum and a D value can be a difference between the intensities for the two alleles or a transformation of a difference. For each marker, a statistical or a numerical model can be employed to determine a potential association of the S and/or the D value with one or more outcomes of the biological sample set, wherein a statistically significant coefficient of the S intensity indicates an association of the copy number with the outcome and a statistically significant coefficient of the D intensity indicates an association of the allelic contrast with the outcome. In embodiments where an S and/or D value are a transformation, they are optionally a monotone transformation. For example, an S value can be computed as the logarithm of the sum of the intensities. Likewise, a D value can be computed as the log of the ratio of the intensities of each allele (log(A/B), In another example, such as for a dominant/recessive model, a transformation of a difference can be computed as f(log(A/B))=1 when log₂(A/B)>0.5, or when A/B>sqrt(2), and =0 otherwise. See also Examples 3, 6, and 8. In some embodiments, the biological sample set comprises a binary outcome-type study, an ordinal outcome-type study, or a continuous (quantitative) outcome-type study. In some embodiments, the biological sample set is selected from a group including but not limited to a case versus control study, a subject cell versus matched cell study, and a tumor cell versus normal cell study. In some embodiments, the method comprises normalizing the measurements of intensity. In some embodiments, the measurements are intensity measurements of oligonucleotide probe hybridization signals.

In some embodiments, the method comprises creating a matrix for the S values and for the D values, wherein the S values for each biological sample for each marker are ordered to be the columns of the S matrix and the markers are ordered to be the rows of the S matrix, and wherein the D values for each biological sample for each marker are ordered to be the columns of the D matrix and the markers are ordered to be the rows of the D matrix. One of ordinary skill in the art understands the ordering of matrices, and thus knows that the S or D matrix can be oriented such that the markers are ordered to be the columns and the S or D values are ordered to be the rows and still fall within the calculations of the present subject matter.

In some embodiments, the method comprises computing a singular value decomposition (SVD) for the S matrix and for the D matrix, wherein the SVD for the S matrix=U_{S} Σ_{S} V_{S}^{t} and the SVD for the D matrix=U_{D} Σ_{D} V_{D}^{t}, and wherein one or more diagonal values of the Σ_{D} and of the Σ_{S} that are associated with a dispersed nuisance effect are zeroed. In some embodiments, the method comprises computing a new sum value matrix (S′) and a new difference value matrix (D′), after the one or more diagonal values having dispersed effects are zeroed. In some embodiments, the method comprises filtering the D′ matrix rows and the S′ matrix rows that either exceed a predetermined level of variability or fall below a predetermined level of invariability.

In some embodiments, the statistical model is a model for binary, ordinal or continuous outcomes. In some embodiments, the model for binary, ordinal or continuous outcomes is a general linear model. In some embodiments, the general linear model is a logistic regression model. In some embodiments, the statistical model is a logistic regression model for binary outcomes. In some embodiments, the statistical model is a multivariate model. In some embodiments, the statistical significance of the coefficient is computed as a p-value. In some embodiments, the employing the statistical or numerical model comprises determining a potential association of one or more non-genetic factors and the S and D values with the one or more outcomes. In some embodiments, the non-genetic factors are selected from the group including but not limited to clinical parameters, demographic data, environmental factors, and combinations thereof. In some embodiments, the employing the statistical or numerical model comprises employing a full statistical model, which includes the genetic values S and D and the non-genetic factors, and a reduced statistical model, which only includes the non-genetic terms. A statistically significant result obtained from the comparison of the two models can indicate an association of the genetic terms with the outcome.

In some embodiments of the presently disclosed subject matter, a system is provided useful for performing genomic marker association studies wherein allelic contrast and copy number are analyzed simultaneously, comprising: a receiving module for receiving, for each marker, one or more measurements of intensity for each of two alleles (A and B) for each sample in a biological sample set; and a computing module for computing, for each marker, a sum value (S) and a difference value (D) of the intensities; and for employing, for each marker, a statistical or a numerical model to determine a potential association of the S and/or the D value with one or more outcomes of the biological sample set, wherein a statistically significant coefficient of the S intensity indicates an association of the copy number with the outcome and a statistically significant coefficient of the D intensity indicates an association of the allelic contrast with the outcome.

In some embodiments of the presently disclosed subject matter, a computer-readable medium is provided having stored thereon computer executable instructions that when executed by the processor of a computer perform steps comprising: receiving, for each marker, one or more measurements of intensity for each of two alleles (A and B) for each sample in a biological sample set; computing, for each marker, a sum value (S) and a difference value (D) of the intensities; and employing, for each marker, a statistical or a numerical model to determine a potential association of the S and/or the D value with one or more outcomes of the biological sample set, wherein a statistically significant coefficient of the S intensity indicates an association of the copy number with the outcome and a statistically significant coefficient of the D intensity indicates an association of the allelic contrast with the outcome.

The subject matter described herein for performing genomic marker association studies wherein allelic contrast and copy number are analyzed simultaneously can be implemented in hardware, software, firmware, or any combination thereof. As such, the term “module” as used herein refers to hardware, software, and/or firmware for implementing the feature being described. In one exemplary implementation, the subject matter described herein can be implemented using a computer readable medium having stored thereon computer executable instructions that when executed by the processor of a computer perform steps of the aforementioned methods (see above). Exemplary computer readable media suitable for implementing the subject matter described herein includes disk memory devices, programmable logic devices, and application specific integrated circuits. In one implementation, the computer readable medium can include a memory accessible by a processor. The memory can include instructions executable by the processor for implementing any of the methods for performing genomic marker association studies wherein allelic contrast and copy number are analyzed simultaneously as described herein. In addition, a computer readable medium that implements the subject matter described herein can be located on a single device or computing platform or can be distributed across multiple physical devices and/or computing platforms.

Accordingly, it is an object of the presently disclosed subject matter to provide methods of simultaneously performing analysis of allelic contrast and copy number association in genome-wide association studies. This and other objects are achieved in whole or in part by the presently disclosed subject matter.

An object of the presently disclosed subject matter having been stated hereinabove, other aspects and objects will become evident as the description proceeds when taken in connection with the accompanying Drawings and Examples as best described herein below.

### BRIEF DESCRIPTION OF THE DRAWINGS

FIG. 1 is a schematic diagram showing the traditional three-state model of genotype.

FIGS. 2a-2b are cluster graphs generated using mock data to represent genotypes AA, AB and BB on log 10 intensity scale for two independent genetic markers. For both FIGS. 2a and 2b, the vertical axis is B allele intensity and the horizontal axis is A allele intensity.

FIG. 2a shows the appearance of three distinct clusters, allowing for accurate calling of individual genotypes.

FIG. 2b, in contrast to FIG. 2a, shows potential overlap between the BB and AB groups, leading to the potential for incorrect assignment of genotypic state (classification error). Also, there are several points that appear distinct from the large clusters and their nature is unclear for classification purposes.

FIG. 3 is a schematic diagram of a multi-state model of genotype that is not restricted by an assumption of having only two total copies of alleles per locus (ie, not restricted to AA, AB, BB).

FIG. 4 is a schematic diagram of the multi-state model of genotype shown in FIG. 3 where two separate sets of axes (sum and difference axes and A and B axes on the diagonal) have been superimposed on the genotypic states. The sum axis represents the total allele count or copy number and the difference axis represents the difference in allele sequence or allelic contrast. The figure illustrates that genotypic state can be viewed equivalently as allele-specific copy number ordered pairs of A and B or as sum and difference ordered pairs (A+B and A−B). The integer labels are theoretical.

FIGS. 5a-5b are idealized graphs of sum values (S) versus difference values (D) of the intensities of two alleles, for a particular genetic marker, for a collection of 80 independent samples having a distinct phenotype. The S and D values are indicated by dark diamond-shaped points. In both FIGS. 5a and 5b, the large circle-shaped point indicates the center of mass of the S and D points indicating a possible association between phenotype and allelic contrast (horizontal shift) or copy number (vertical shift) subject to statistical testing. The statistical algorithm to determine if there are significant differences between the two phenotypes based on allelic content does not depend on having a genotypic classification of each biological sample.

FIG. 5a shows a plot of the sum versus difference values for subjects having phenotype 1. The observed large circle-shaped point represents the center of mass of phenotype 1.

FIG. 5b shows a plot of the sum versus difference values for a collection of subjects having phenotype 0. The observed large circle-shaped point represents the center of mass of phenotype 0. There is an observed shift between FIGS. 5a and 5b both vertically and horizontally in the circle-shaped point potentially indicating an association between this marker and phenotype. Confirmation of the association can be achieved via a statistical test for association.

FIGS. 6a-6b are quantile-quantile plots of coefficients of expected versus observed S values (SUM) and D values (DIFF). Both plots show significant deviation from the expected line indicating the presence of numerous markers having scores higher than expected due to chance alone in a set of HapMap samples.

FIG. 6a shows the expected versus observed coefficients for the intensities of the sum of the two alleles (sum value (S)=total allele count or copy number) for the collection of genetic markers analyzed.

FIG. 6b shows the expected versus observed coefficients for the intensities of the difference between the two alleles (difference value (D)=difference in allele type or allelic contrast) for the collection of genetic markers analyzed.

FIGS. 7a-7d are scatter plots of S values versus D values for measurements of a single marker across each of 270 HapMap samples for a Yoruban (grey crosses) and a non-Yoruban (black crosses) population. Each of the graphs in FIGS. 7a-7d depicts the S and D values for a separate marker.

FIG. 7 demonstrates a lack of association of either the SUM or the DIFF with the phenotype for the particular marker analyzed (p>0.1 for both terms).

FIG. 7b demonstrates an association of the DIFF, i.e. allelic contrast or allele sequence variation, with the phenotype for the particular marker analyzed (p>0.1 for SUM and p<0.01 for DIFF).

FIG. 7c demonstrates an association of the SUM, i.e. copy number, with the phenotype for the particular marker analyzed (p<0.01 for SUM and p>0.1 for DIFF).

FIG. 7d demonstrates an association of both the SUM, i.e. copy number, and an association of the DIFF, i.e. allelic contrast or allele sequence variation, with the phenotype for the particular marker analyzed (p<0.01 for SUM and DIFF).

FIGS. 8a-8f are plots of p-values for coefficients of Sum values (FIGS. 8a, 8c & 8e) and Diff values (FIGS. 8b, 8d & 8f) plotted by location in the genome for representative chromosomes. The scatter in the p-values (gray points) indicates the extreme p-values measured throughout the genome. Patterns of sustained higher p-values resulting after Loess smoothing of the raw p-values (dark lines) identify regions in the chromosome of associations between copy number (Sum graphs) and allele contrast (Diff graphs).

FIGS. 8a & 8b are plots of p-value coefficients for sum values (FIG. 8a) and difference values (FIG. 8b) plotted by location in the genome for chromosome 1.

FIGS. 8c & 8d are plots of p-value coefficients for sum values (FIG. 8c) and difference values (FIG. 8d) plotted by location in the genome for chromosome 11.

FIGS. 8e & 8f are plots of p-value coefficients for sum values (FIG. 8e) and difference values (FIG. 80 plotted by location in the genome for chromosome 17.

FIG. 9 illustrates an exemplary general purpose computing platform 100 upon which the methods and systems of the presently disclosed subject matter can be implemented.

FIGS. 10a-10c are cluster graphs showing examples of SNP clusters and calling. Homozygous clusters are at the extremes of “Norm Theta” with heterozygotes in-between. Missing calls are depicted as white circles with smaller black dots which are usually outside the darker gray regions.

FIG. 10a is a cluster graph showing a typical SNP (rs12884681) which has few missing calls and well-defined clusters. Nevertheless, it significantly deviates from Hardy-Weinberg Equilibrium (HWE) assumptions (p<10⁻¹⁵) and would normally be removed as it is assumed that the deviation is primarily due to measurement error.

FIGS. 10b and 10c are cluster graphs with a much higher no-call rate. Homozygous clusters are at the extremes of “Norm Theta” with heterozygotes in-between. In FIG. 10b, the SNP (rs31421) has 5.4% missing calls which are outside the darker gray regions containing well-defined clusters. In FIG. 10c, the SNP (rs3915831) has 12.2% missing calls.

FIG. 11a is a plot showing that the FGFR2 region is reproduced as being statistically significant without the requirement that genotype calls be created.

FIG. 11b is a plot showing that the greater significance of p-values of the results of the presently disclosed methods versus those reported for the FGFR2 SNPs. Crosshairs correspond to the top four SNPs from FGFR2 region.

FIG. 12 is a plot showing the comparison of the p-values of the results of the presently disclosed methods versus the p-values from the classic chi-squared test of association in a Monte Carlo simulation of a variety of GWAS with important factors varied over a large grid of parameter values (Sample size, penetrance, MAF, CV of probe intensity).

FIGS. 13a and 13b are plots showing a comparison of standard p-values in simulated data versus p-values of the presently disclosed methods.

FIG. 13a is similar to FIG. 12 but the Cochran-Armitage trend test was used. No CNV were simulated.

FIG. 13b shows a simulation using only the data from studies with a sample size of 2000. Points with circles indicate SNP simulations with CNV present. Points with grey x's indicate no CNV present, thus it will look identical to FIG. 13a for those points associated with a study with a sample size of 2000.

### DETAILED DESCRIPTION

The presently disclosed subject matter provides methods and systems for performing simultaneous allelic contrast and copy number association in genome-wide association studies (GWAS). In the some embodiments of the presently disclosed subject matter, phenotypic associations with copy number and allelic contrast are performed simultaneously. Also provided in the presently disclosed subject matter are computer readable media instructions for performing the disclosed methods.

GWAS are useful for discovering genetic and, potentially, epigenetic factors that contribute to the development, progression, and/or treatment options for a particular disease or trait such as high blood pressure and obesity. GWAS are particularly useful for the study of common, complex diseases, such as asthma, cancer, diabetes, heart disease and mental illnesses, where the individual genetic contributions to the disease are expected to be relatively weak. When combined with clinical, environmental and other phenotypic data, analysis of whole genome information offers the potential for increased understanding of basic biological processes affecting human health and improvement in the prediction of disease and treatment options.

Current GWAS methods are limited to identifying genome-wide associations of variations in allele frequency with a phenotypic endpoint. One motivation for additionally determining accurate genome-wide estimations of copy number is an increasing number of studies reporting a phenotypic association with a variation in total copy number. However, current methods for determining allelic contrast and allele-specific copy number are each limited to the categorization of the data into discrete genotypes and copy number states. This process results in information loss for markers that fall near the boundaries of these states and is also weakened by potentially unnecessary assumptions (i.e. three-state model of genotypes). Therefore, data are frequently put in a form that is suboptimal for discovery where the data might have otherwise provided an indication of an association with a disease or disorder phenotype.

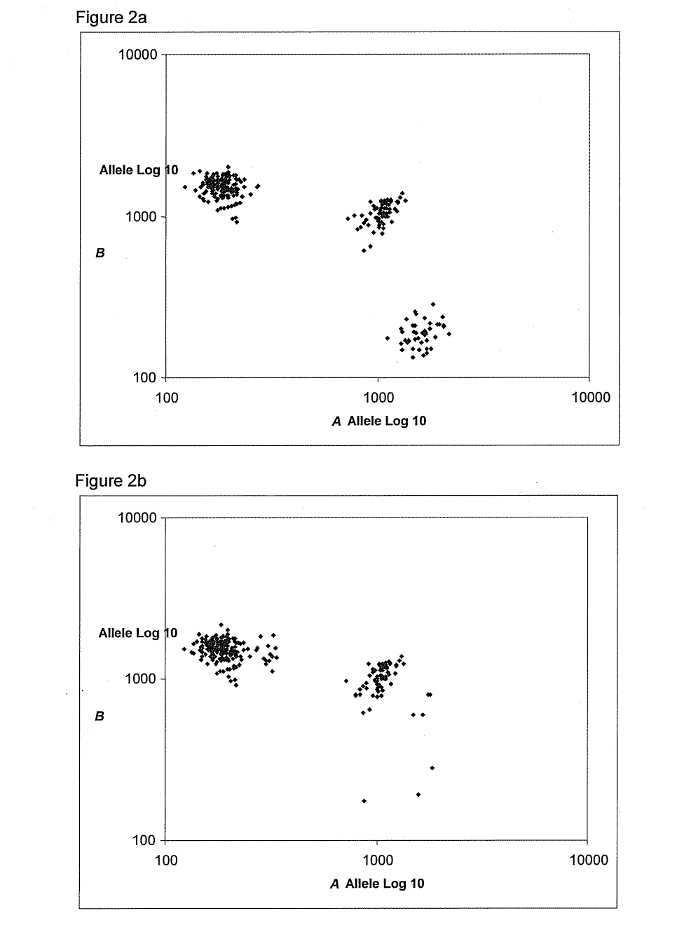

An example illustrating some of the limitations of the current approach for performing GWAS are shown in FIGS. 2a-2b. FIGS. 2a-2b show cluster graphs generated using mock data to represent estimated genotypes AA, AB and BB on a log 10 intensity scale for two independent genetic markers. For both FIGS. 2a and 2b, the vertical axis is B allele intensity and the horizontal axis is A allele intensity. In a traditional analysis, each allele would be categorized into a genotype “call” of AA, AB, or BB. In FIG. 2a, there appear to be three distinct clusters, allowing for accurate calls of individual genotypes using the traditional technology. However, the graph shown in FIG. 2b shows potential overlap between the BB and AB groups, leading to the potential for incorrect assignment of genotypic state (classification error). Also, there are several points that appear distinct from the large clusters and their nature is unclear for classification purposes.

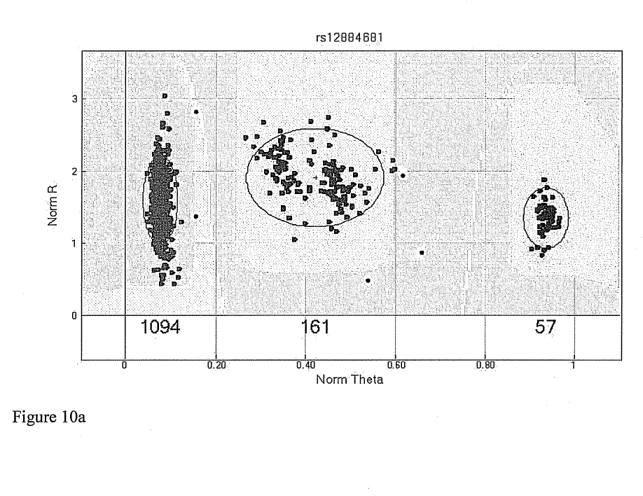

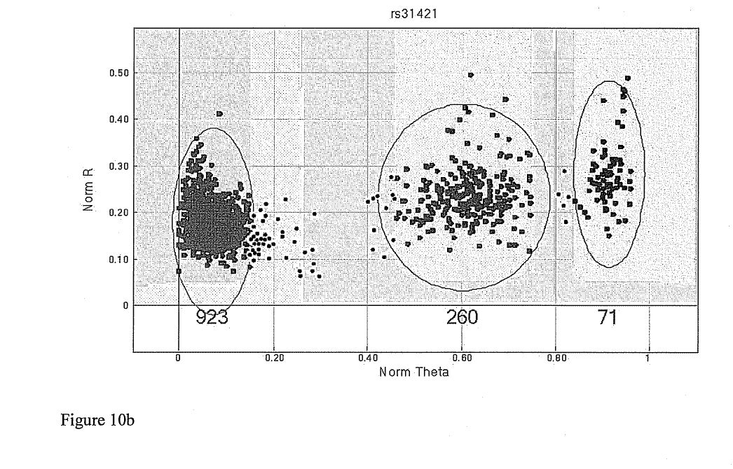

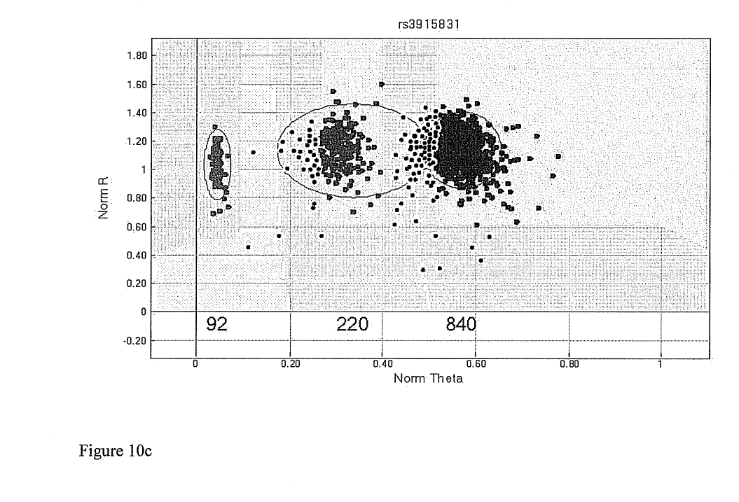

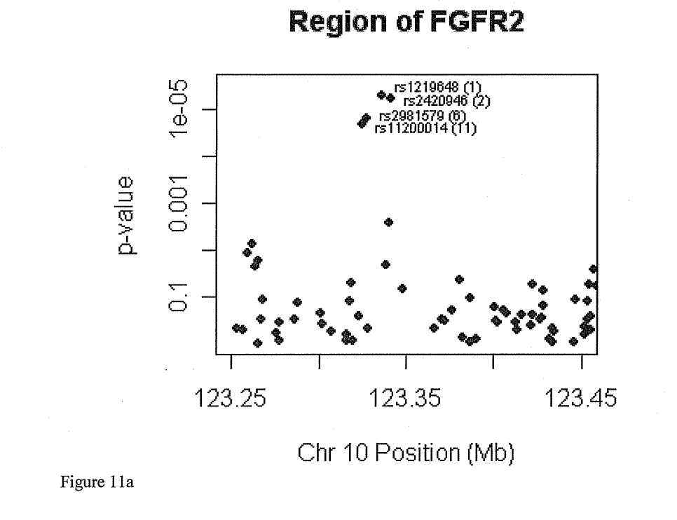

A second example illustrating some of the limitations of the current approach is shown in FIGS. 10a-c. The illustrated SNPs are actual data from a GWAS of roughly 1300 subjects. These figures provide detailed allelic measurement views of three SNPs from this study that would be considered problematic to analyze. In each case, we see examples of transforms of summed intensity (in this case, R=log(A allele intensity+B allele intensity)) on the y-axis versus transforms of the difference in intensity (the angle θ of intensity of A allele vs. B allele is equivalent to tan⁻¹(A allele intensity)/(B allele intensity)) on the x-axis. The angle θ is one example of a transformation of the allelic contrast. In a traditional analysis, each allele would be categorized into a genotype “call” or AA, AB, or BB. FIG. 10a is a somewhat typical plot of R vs. θ with few resulting missing calls (indicated by white circles containing smaller black dots). Nevertheless, this SNP deviates from Hardy-Weinberg Equilibrium (HWE) assumptions and is often removed prior to analysis as it is commonly thought that SNPs deviating from HWE do so as a result of poor cluster discrimination or measurement error. Alternatively, one frequently sees plots like FIGS. 10b and 10c. In both of these plots, it is clear that the missing genotypes convey useful information that would be lost using the standard methodology of calling whereby subjects with ‘no calls’ are removed. Sometime, if the percentage of ‘no calls’ for a SNP are high enough, the SNP itself is removed. Overall, 2%-15% of SNPs are often removed or have their power diminished for these reasons within a GWAS, yet it is clear from these examples that there is well-ordered information that can be gleaned from these samples using these SNPs.

In contrast to the traditional approaches to GWAS, the presently disclosed subject matter allows for phenotypic association of both copy number and allelic contrast to be modeled simultaneously. In addition, classification of a marker into a specific genotype state is not required. It is shown herein that transforming individual allelic intensity measurement data by taking the sum or difference of two allele intensity measurements at a particular marker allows for the simultaneous identification of potential phenotypic associations with copy number and allelic contrast.

In some embodiments, the presently disclosed subject matter provides methods and systems for determining allelic contrast and copy number association in a genome-wide association study from massively parallel measurement instruments such as microarrays. In the methods and systems provided, continuous signal data of copy number and allelic contrast are analyzed simultaneously. The methods and systems can include the steps of data normalization and/or removal of unwanted nuisance factors associated with technical and population bias. The presently disclosed methods and systems unify the previous methods of separately examining genotype and copy number in association studies. Accordingly, the terminology of simultaneous allelic contrast and copy number association is herein introduced to indicate this unified approach. Advantages of the unified approach described herein include an ability to simultaneously associate copy number and allelic contrast with one or more phenotypic outcomes or endpoints, a general simplification of analysis steps, and a provision of an extensible framework for inclusion of clinical, demographic, and environmental (including exposure) factors in addition to the genetic allelic factors and interactions typically analyzed that can be associated with the phenotypic outcomes.

The methods, systems and computer readable media are described in connection with the accompanying Figures and Examples in further detail herein below.

While the following terms are believed to be well understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter belongs. Although any methods, systems, and materials similar or equivalent to those described herein can be used in the practice or testing of the presently disclosed subject matter, representative methods, systems, and materials are now described.

Following long-standing patent law convention, the terms “a”, “an”, and “the” refer to “one or more” when used in this application, including the claims. Thus, for example, reference to “a sum value (S)” includes a plurality of such S values, and so forth.

Unless otherwise indicated, all numbers expressing quantities of measurements, S values, D values, p-values and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, “each of two alleles (A and B)” means one of the possible alternative forms of a DNA sequence. Use of the term “allele” (short for allelomorph) has historically been associated with genes, but is now used more generally in some cases to describe variants at the same genetic locus. Alleles are typically denoted or labeled in shorthand form as simply A and B or as A and a. In some cases, the A label is assigned to be the allele observed in a majority of the cases being studied and the B allele is observed in a minority of the cases being studied. However, the frequency of an allele is population dependent. As used herein, two possible alternative forms of an allele will be denoted as A and B without any limitation regarding majority and minority frequencies. By way of example only and not meant as limiting, allele A can refer to a nucleotide sequence at a particular genetic locus that is observed in the majority of the population being studied, and allele B can refer to a particular SNP at that same locus observed less frequently. In another non-limiting example, allele A can refer to the presence of a specific methlyation pattern at a particular genetic locus that is observed in the majority of the population being studied, and allele B can refer to a methlyation pattern at that same locus observed less frequently.

As used herein, “allelic contrast” is meant to refer to an assessment of the relative number of copies of the alleles at a particular genetic location. If there are two alleles A and B and some quantification of the number of copies of A and B (referred to as copy(A) and copy(B)), then allelic contrast would be the number of copies of A relative to B (copy(A)−copy(B) or copy(A)/copy(B)). If measuring alleles from an instrument, it would be the measurement of signal intensity of A relative to the measurements of signal intensity of B (signal(A)−signal(B) or signal(A)/signal(B)). As used herein, A−B will be used to represent any of the following: copy(A)−copy(B), copy(A)/copy(B), signal(A)−signal(B). signal(A)/signal(B)). In some embodiments of the presently disclosed subject matter, the measurements of signal intensities for A and B are transformed and/or normalized.

The types of “biological samples sets” useful in the presently disclosed subject matter include, but are not limited to, those comprising samples taken from a binary outcome-type study, an ordinal outcome-type study, or a continuous (quantitative) outcome-type study. What is meant by a “binary outcome” is an outcome that has two and only two potential states. By way of example and not meant to be limiting, a binary outcome is an outcome including: (alive/dead), (0/1), (Yes/No), (Present/Absent), (A/B), (A/˜A) and (Male/Female). Again, by way of example only, a binary outcome can also include a study that has a more continuous outcome that has been recoded to a binary-type outcome (e.g., a cholesterol level above or below 200). An ordinal outcome is an outcome that has two or more states that can be ordered, but the relative distance between the states is not necessarily measurable. Again, by way of example only and not limitation, ordinal outcomes include (Low/Medium/High), (Hot/Warm/Cold) and (Strongly Agree/Agree/Neither Agree or Disagree/Disagree/Strongly Disagree). A continuous (quantitative) outcome is an outcome where the relative or absolute distance between values can be quantitatively determined. By way of example only, continuous outcomes include Age, Weight, Height, Distance, Time, and Temperature.

As used herein, the phrase “copy number” and “total copy number” are used interchangeably and are intended to mean an assessment of the total number of copies of the alleles at a particular genetic location. For example, if there are two alleles A and B and some quantification of the number of copies of A and B (referred to as copy(A) and copy(B)), then the copy number would be the total number of copies of A and B (copy(A)+copy(B))). If allele measurements of signal intensity are received from an instrument, the copy number would be the signal intensity of A plus the signal intensity of B (signal(A)+signal(B)). As used herein, A+B will be used to represent any of the following: copy(A)+copy(B), signal(A)+signal(B). In some embodiments of the presently disclosed subject matter, the measurements of signal intensities for A and B are transformed and/or normalized.

As used herein, the phrase “dispersed nuisance effects” is referring to effects that are shared or are associated with a large number of factors, typically at lower levels and are unrelated to the biological effect(s) of interest.

As used herein, the term “genotype” means the genetic makeup of an organism. Expression of a genotype can give rise to an organism's phenotype, i.e. an organism's physical traits.

As used herein, the terms “marker”, “polymorphic marker”, “polymorphism”, “single nucleotide polymorphism” and “SNP” are used interchangeably and are intended to refer to a genetic marker resulting from a variation in nucleotide sequence at a particular position within a DNA sequence or a variation in epigenetic structure at a particular position (e.g., methylation). Generally, such variation has been found to be extensive throughout all genomes. In some embodiments, a polymorphic marker refers to the occurrence of two or more genetically determined alternative sequences (i.e., alleles) in a population. A polymorphic marker is the locus at which divergence occurs. Preferred markers have at least two alleles, each occurring at a frequency of greater than 1%. A polymorphic locus can be as small as one base pair, for example, a SNP.

As used herein, “measurements of intensity” and “measurements of signal intensity” are used interchangeably and are intended to refer to a measure of the magnitude of energy per unit (as on a surface) that is roughly proportional to the amount of material being measured. As described herein, the material being measured is genetic material for genomic association studies. The form of the genetic material can be any form suitable for obtaining a measure of the magnitude of energy per unit that is roughly proportional to the amount of material being measured. A number of apparatuses and detection methods are suitable for producing the measurements of intensity that can be received for use with the currently disclosed subject matter, including but not limited to, for example, microarray hybridization devices, mass spectrometric and other spectrometric and spectroscopic devices for use with fluorescent, phosphorescent, chemiluminescent, radioactive or other detection methods that can convey a magnitude or signal intensity commensurate with the targeted material being measured.

As used herein a “nuisance effect” is an effect that is technical in origin and is not necessarily of scientific value. Such nuisance effects typically interfere with the understanding of the primary and secondary effects of interest in a particular scientific study.

As used herein, a “statistical or a numerical model” to determine a potential association of an S and/or D value with one or more outcomes of a biological sample set relates to employing a statistical model of association that has independent variables (or inputs) that are associated in equation form with one or more dependent variables (or outputs). However, “statistical or numerical model” is used herein in a manner to include error. For example, in addition to the primary effects or independent variables associated with genetic and other factors, the model has a mechanism to account for stochastic effects. An “association” is intended to refer to a phenomenon where two events are connected in some fashion. For example, the events can tend to co-occur or the events can tend to have one absent when the other is present. A numerical model is meant to refer to a model that can receive quantitative or qualitative inputs, perform calculations, and then provide a quantitative or qualitative output that approximates the behavior of a phenomenon. As used herein, the phrase “statistical models” is meant to refer to all statistical and numerical models. This is in spite of the phrase “numerical models” (such as models of deterministic systems) being used by some in the art in a more narrow sense that might not be viewed as statistical. Herein, the phrase “statistical models” is meant to refer to all statistical and numerical models.

As used herein, “significance”, “significant”, “statistical significance” or a “statistically significant coefficient” relate to a statistical analysis of the probability that there is a non-random association between two or more results, endpoints or outcomes. Statistical significance relates to a result or to a test outcome that is not likely to be due to chance alone. A statistically significant coefficient means, in statistical models, a coefficient related to one of the inputs or independent variables where the coefficient is deemed statistically significant (and thus, not equal to zero). A statistically significant coefficient implies that the input or independent variable is useful in the presence of the other factors when estimating the output. For example, in some embodiments of the presently disclosed subject matter, a statistically significant coefficient of the S intensity indicates an association of the copy number with the outcome and a statistically significant coefficient of the D intensity indicates an association of the allelic contrast with the outcome.

To determine whether or not a relationship is “significant” or has “significance”, or there is a “statistically significant coefficient”, statistical manipulations of the data can be performed to calculate a probability, expressed as a “p-value”. Those p-values that fall below a user-defined cutoff point are regarded as significant implying that they are of further interest. In the presently disclosed subject matter, considerations for p-value thresholds can depend on context and the level of multiple testing. By way of example only and not meant as limiting, if a large number of SNPs (>10) are examined, then the number of tests being conducted is taken into account when considering p-value thresholds. This can reduce the false positive rate for deeming a SNP to be associated with an outcome. For example, if testing one million SNPs (1×10⁶ SNPs), then it is common for a p-value threshold to be set at or lower than 1×10⁻⁷. However, other factors can be taken into consideration including, for example, whether or not there is prior evidence that a SNP is associated with outcome. Depending on prior evidence, the threshold for p-value can be set much lower (e.g., 1×10⁻⁴).

Further, as used herein, “filtering the D′ matrix rows and the S′ matrix rows that either exceed a predetermined level of variability or fall below a predetermined level of invariability” is meant to refer to a threshold for a variability measure (such as standard deviation) that is determined from prior information or study.

As used herein, the terms “sum”, “sum value” and “S” are interchangeable and the terms “difference”, “difference value”, “duff”, “diff value” and “D” are interchangeable. By way of a non-limiting example, an S value can be a sum of the intensities for the two alleles or a transformation of a sum and a D value can be a difference between the intensities for the two alleles or a transformation of a difference. For each marker, a statistical or a numerical model can be employed to determine a potential association of the S and/or the D value with one or more outcomes of the biological sample set, wherein a statistically significant coefficient of the S intensity indicates an association of the copy number with the outcome and a statistically significant coefficient of the D intensity indicates an association of the allelic contrast with the outcome. In embodiments where an S and/or D value are a transformation, they are optionally a monotone transformation. For example, an S value can be computed as the logarithm of the sum of the intensities. Likewise, a D value can be computed as the log of the ratio of the intensities of each allele (log(A/B), In another example, such as for a dominant/recessive model, a transformation of a difference can be computed as f(log(A/B))=1 when log₂(A/B)>0.5, or when A/B>sqrt(2), and =0 otherwise. See also Examples 3, 6, and 8. The term S can refer to a sum of the signal intensities for each of two alleles A and B (e.g., A+B) and the term D can refer to a difference or contrast of the signal intensities from each of two alleles A and B (e.g., A−B). In some embodiments of the presently disclosed subject matter, S and D are transformed and/or normalized.

Genome-Wide Association Studies (GWAS) are a result of recent developments in new technologies that can quickly and accurately analyze whole-genome samples for single nucleotide polymorphisms (SNPs), copy number variants (CNVs), and methylation sites. Typically, GWAS are carried out on large groups of individuals, some of whom have the disease being studied and some with similar characteristics who do not have the disease. However, GWAS can also be relevant for the study of tissues that have undergone small to large mutational changes. For example, the GWAS of the presently disclosed subject matter can be performed using biological sample sets including but not limited to, for example, case-control, normal-abnormal tissues, and/or matched-subject tissues. In some embodiments the biological sample sets include tissues that have been analyzed for patterns of methylation. In one embodiment, the biological sample sets include tissues from oncology studies.

In some embodiments, the methods and systems of the presently disclosed subject matter are useful with GWAS where the entire genome of a person or tissue is scanned to identify the specific SNPs, CNVs, and/or methylation sites at an appropriate number of marker sites along the chromosomes (depending on the population being studied, this can range from about 100,000 to 10 million markers). If certain genetic or epigenetic variations are statistically found to be more frequent in people (or tissues) with the disease than in people (or tissues) without the disease, the marker can be said to be “associated” with the disease. The associated genetic and epigenetic variations can serve as guides to the region of the human genome where the contributor to a disease potentially resides.

Typically, GWAS are most informative when a study population is large. The larger the population, the greater the statistical power to determine that observed associations are real and not due to chance. Research has shown that some populations demonstrate a higher predisposition to develop certain medical diseases or disorders than others. GWAS can provide insight into how certain variants contribute to health and disease and can also increase knowledge of how genetic and epigenetic variants differ in frequency between and among populations and tissues. Genetic and epigenetic variants associated with physical disorders, diseases, and behavioral traits can be discovered using GWAS.

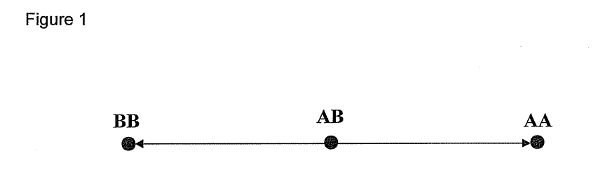

However, current methods for performing GWAS are limited to the categorization of the data into discrete genotypes. This is true for both the determination of allelic variation and for the determination of copy number. The relative frequency of any two alleles (A and B) at the same genetic location is transformed into a genotype consisting of one of three states: AA, AB or BB (see FIG. 1). Methods currently employed in the art include this three-state model and a corresponding assumption that the genome contains normal copy number in order to assign one of the three possible genotypes to each genomic location. The genotypes are then tested for a probability of association with a given phenotype. Because the background art methods assume the genome can be characterized by three states at any particular locus, when there is ambiguity in a data point falling outside of these states it is categorized as a “no call” state. The no call states are typically thought to be the result of poor quality data, rather than being considered the result of mistaken assumptions about genomic state.

The effect of the narrow assumption in the art is clearly visible by noting that the very same probe measurements which provide, for example, SNP genotypic calls of AA, AB, BB and no call are also used to assess copy number variants (whose assumptions are in direct conflict with the three-state assumption of genotype), even within the same study. In addition, the analysis of SNP marker associations and copy number associations are typically performed separately, as if the analyses were two independent studies. That is, typically an AA, AB, BB, or no call analysis is performed for association with a disease of interest, and then copy number variation is examined retroactively as a separate additional analysis. However, this approach results in failure to identify a potential phenotypic association with copy number variation because the model is restricted to the three-state assumption of genotype at any particular genetic locus, and does not allow for a potential variation in copy number. Given the increasing awareness of the importance of copy number variants in disease (e.g., copy number variations are well-known in certain mental and developmental disorders) it is inefficient to limit a GWAS analysis to the three-state genotypic model that fails to reflect copy number variation possibilities.

The approach currently employed in the art prior to the instant disclosure is further exemplified as follows: in a case-control study, the primary goal is to associate the three genotypic states or something simpler (such as presence of A or not) with a phenotypic outcome. In the three state model of genotype as illustrated in FIG. 1, the traditional approach to identifying associations is illustrated in Table 1 and Table 2. The approach assumes population-matched controls and high quality data measured at two independent loci. Use of the Cochran-Armitage linear trend test results in the data provide in Table I and Table II:

TABLE I
Locus 1

| | No. of | Genotype (%) | | | |
|---|---|---|---|---|---|
| Phenotype | Subjects | A₁A₁ | A₁B₁ | B₁B₁ | Total |
| Present | 1300 | 56% | 38% | 6% | 100% |
| Not | 1000 | 67% | 30% | 3% | 100% |
| Present | | | | | |

| | |
|---|---|
| Test-Assoc | p-value (two-sided) = <10⁻⁸ |

TABLE 2
Locus 2

| | No. of | Genotype (%) | | | |
|---|---|---|---|---|---|
| Phenotype | Subjects | A₂A₂ | A₂B₂ | B₂B₂ | Total |
| Present | 1300 | 90% | 9.7% | .26% | 100% |
| Not | 1000 | 88% | 10.5% | 1.5% | 100% |
| Present | | | | | |

| | |
|---|---|
| Test-Assoc | p-value(two-sided) ≦ .03 |

In this example, Locus 1 provides a much stronger indication of the alleles being associated with phenotype.

Even though the three-state model is the basis for most genetic association studies, it is known that some diseases (especially developmental disorders and oncology) are attributable to amplification (gain) or deletion (loss) of various genetic regions. The gain or loss can occur in either constitutional DNA or in mutated cells. For example, Down Syndrome implies a gain of an entire chromosome 21. In addition, in various cancer cells and cancer cell lines, there are frequently regions of complete loss of both alleles or multiple amplifications. When the genomic variability is viewed from this perspective, it can be seen that multiple (>3) states of genotype are not only theoretically possible but, in fact, occur.

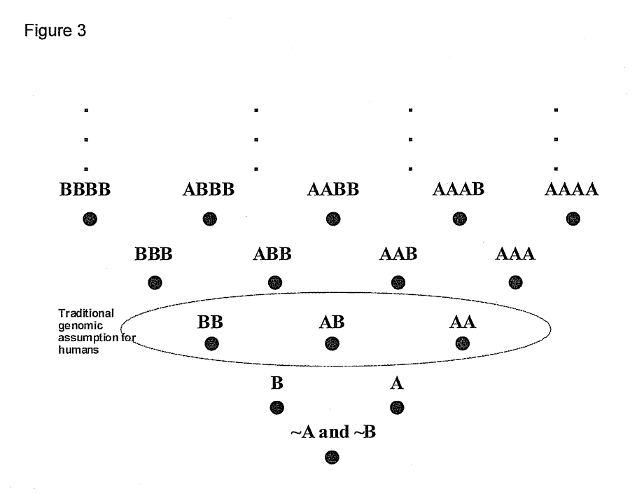

In contrast to the approach taken in the art, the presently disclosed subject matter provides a more general view of allelic contrast at any given locus (see FIG. 3). In addition, if the schematic model of genotypic states shown in FIG. 3 is accepted as providing a more complete representation than the traditional three-state model, then the new model can also be viewed as providing an intuitive representation of what is important about allelic association in genetic association studies. That is, the vertical axis indicates the copy number (sum total allelic count) the horizontal axis indicates the degree to which the allelic types differ (allelic contrast). Copy number and allelic contrast are the two primary genetic factors of interest when developing genetic associations with a phenotypic outcome.

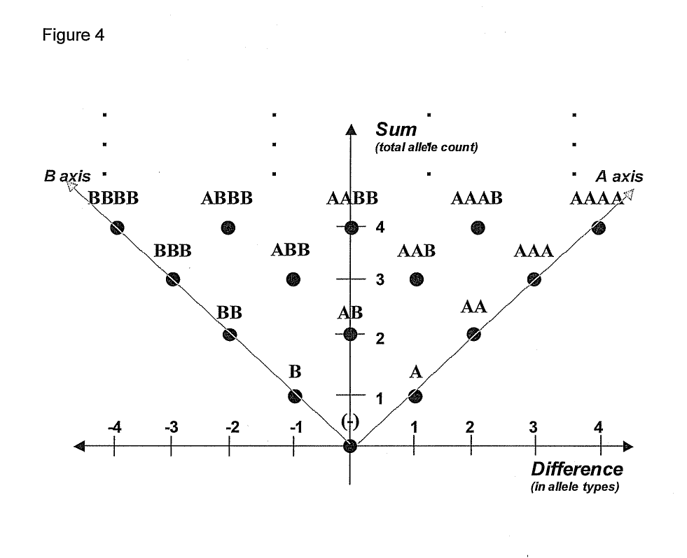

FIG. 4 is a schematic diagram of the multi-state model of genotype shown in FIG. 3 where two separate sets of axes (sum and difference axes and A and B axes on the diagonal) have been superimposed on the genotypic states. The integer labels in FIG. 4 are theoretical. From FIG. 4, it can be seen that allelic contrast (A−B) versus copy number (A+B) is geometrically equivalent in relative position to the ordered pair of number of copies of A and the number of copies of B, or simply (A,B). In FIG. 4, the Sum axis represents the copy number and the Difference axis represents allelic contrast. FIG. 4 illustrates that genotypic state can be viewed equivalently as allele-specific copy number ordered pairs of A and B or as sum and difference ordered pairs of A+B and A−B. The copy number is herein termed “S” and the allelic contrast (is herein termed “D”. Therefore, every point in FIG. 4 is an ordered pair (D, S).

One advantage of using the presently disclosed perspective of allelic sum and difference is the ability to view intensity measurements of allelic count as an approximate process that contains measurement error. The source of the measurement error is typically related to the inherent variability of the measurement platform. GWAS are usually carried out using oligonucleotide microarrays. Microarray measurement is based on probe hybridization kinetics in which hybridization conditions are generally suitable for the several hundred thousand to million distinct probes that are present on a single microarray, but is not optimized for individual probes. In addition, the amount of labeled target applied to the microarray can be a product of amplification and reverse transcription reactions that does not necessarily reflect the relative proportion of the original DNA segments represented (e.g., due to biases such as amplification bias).

In addition to the measurement error described above, the historic assumption of a three state model of genotype can create additional error or a lack-of-fit of data to the model. For example, when attempting to associate signals from the A and B alleles with an AA, AB, or BB genotypic state, whenever the true genotype is, for example, AAB or simply A, a lack of fit error can result. Further, a true AAB genotype can be confused with or misclassified as an AA or AB genotype. In addition, a true genotype A might show a distinct signal difference from a true AA genotype. However, the reduction in an A signal versus an AA signal can be mistakenly interpreted as stochastic variation, when in fact the signal is actually reflecting a copy number difference. A manifestation of one type of error created by the prior art approach is illustrated in the graph shown in FIG. 2b showing potential overlap between the BB and AB cluster groups, which leads to the possibility for incorrect assignment of genotypic state. Another type of potential error is shown in FIG. 2b where several points appear distinct from the large clusters. Their nature is unclear for classification purposes using the three-state model as they can reflect copy-number changes. In this manner, the approach employed in the art for GWAS results in genotype classification errors and in loss of potential copy number associations with a phenotypic outcome.

In some embodiments of the presently disclosed subject matter, methods are provided for performing simultaneous allelic contrast and copy number association in genomic marker association studies. In some embodiments, the genomic marker association studies are genome-wide association studies. In some embodiments, allelic contrast and copy number are analyzed simultaneously. In the presently disclosed subject matter, instead of requiring each marker to have an associated genotype call of AA, AB, BB, or no call, a more straightforward and robust way is provided to analyze the genetic data for phenotypic association.

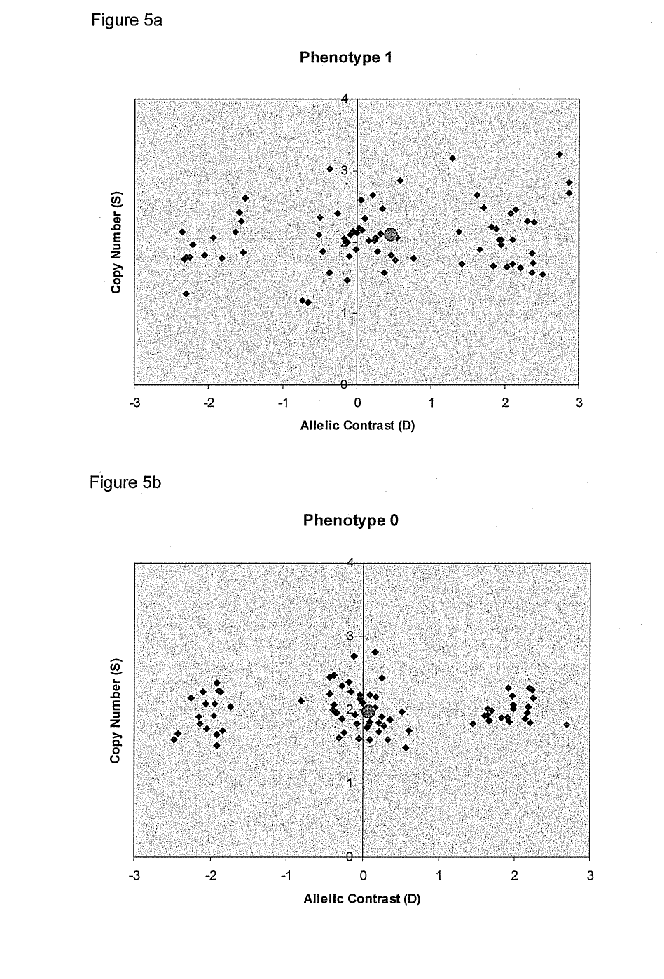

In some embodiments of the presently disclosed subject matter, GWAS are performed by receiving A and B signals from each allele for a collection of subjects from a phenotype, calculating a sum intensity value and a difference intensity value for the A and B signals, and determining if there is a statistically significant shift in the center of mass of the sum and the difference intensity between subjects with the phenotype. The methods are illustrated in FIGS. 5a-5b, 6a-6b, 7a-7d, 8a-8f, 11a-b, 12, and 13a-b and Examples 1-5 and 7-8.

In some embodiments of the presently disclosed subject matter, a method is provided for performing genomic marker association studies wherein allelic contrast and copy number are analyzed simultaneously. A representative method can comprise receiving, for each marker, one or more measurements of intensity per sample for each of two alleles (A and B) for each sample in a biological sample set; computing, for each marker, a sum value (S) and a difference value (D) of the intensities; and employing, for each marker, a statistical or a numerical model to determine a potential association of the S and/or the D value with one or more outcomes of the biological sample set, wherein a statistically significant coefficient of the S intensity indicates an association of the copy number with the outcome and a statistically significant coefficient of the D intensity indicates an association of the allelic contrast with the outcome.

By way of a non-limiting example, an S value can be a sum of the intensities for the two alleles or a transformation of a sum and a D value can be a difference between the intensities for the two alleles or a transformation of a difference. As noted above, for each marker, a statistical or a numerical model can be employed to determine a potential association of the S and/or the D value with one or more outcomes of the biological sample set, wherein a statistically significant coefficient of the S intensity indicates an association of the copy number with the outcome and a statistically significant coefficient of the D intensity indicates an association of the allelic contrast with the outcome. In embodiments where an S and/or D value are a transformation, they are optionally a monotone transformation. For example, an S value can be computed as the logarithm of the sum of the intensities. Likewise, a D value can be computed as the log of the ratio of the intensities of each allele (log(A/B), In another example, such as for a dominant/recessive model, a transformation of a difference can be computed as f(log(A/B))=1 when log_{2 (A/B)>}0.5, or when A/B>sqrt(2), and =0 otherwise. See also Examples 3, 6, and 8.

In some embodiments of the presently disclosed subject matter, the method comprises normalizing the measurements of intensity. In some embodiments, the normalizing comprises normalizing the measurements of intensities to a reference distribution of measurements. In some embodiments, the normalizing of the measurements is performed according to a method of quantile normalization, invariant set normalization, median centering normalization, or combinations thereof. In some embodiments of the presently disclosed subject matter, the A and the B intensities are transformed. In some embodiments, the A and B intensities are normalized for various nuisance affects and on roughly equivalent scales. In some embodiments, the sum and the difference intensities are normalized.

In some embodiments, the measurements are intensity measurements of oligonucleotide probe hybridization signals. In some embodiments the measurements of intensity are direct measurements of nucleotides. In some embodiments, the measurements of intensity are mass spectrometric measurements. In some embodiments, the measurements of intensity represent the degree of nucleotide methylation. In some embodiments, the multiple measurements of intensity for a genetic locus are summarized. In some embodiments, summarization comprises calculating an average or a median.

In some embodiments, the biological sample set is a large number of cases and controls (e.g., >500) and comprises a large number of markers. In some embodiments the number of marker is genome-wide. In some embodiments, the biological sample set comprises a modest number of cases and controls (e.g., <100) and a modest number of markers (e.g., <30). In some embodiments, the biological sample set comprises a binary outcome-type study, an ordinal outcome-type study, or a continuous (quantitative) outcome-type study. In some embodiments, the biological sample set is a non-family based study. In some embodiments, the outcome is a phenotypic outcome or endpoint that is matched in population. In some embodiments, the biological sample set comprises samples where the phenotypic outcomes or endpoints are associated with a small number of the markers and there are nuisance and/or quality issues that affect a larger number of the markers.

In some embodiments, the biological sample set is selected from a group including but not limited to a case versus control study, a subject cell versus matched cell study, and a tumor cell versus normal cell study. For example, in some embodiments, the tumor samples are a mixture of normal cells and cells having DNA that has undergone one or more mutation events. In some embodiments, the biological samples are from matched tissue studies from the same subject or organism. In some embodiments, the method is similar, for example, to a matched or repeated measures design in classical statistical analysis where the analysis is of comparative data rather than primary data.

In some embodiments of the presently disclosed method for performing genomic marker association studies wherein allelic contrast and copy number are analyzed simultaneously, employing, for each marker, a statistical or a numerical model to determine a potential association of the S and/or the D value with one or more outcomes of the biological sample set is flexible. In some embodiments, the statistical model supports binary, ordinal, or continuous outcomes. In some embodiments, the statistical model is a model for binary outcomes. In some embodiments, the model for binary outcomes is a logistic regression model. In some embodiments, the statistical model is a general linear model (GLM). In some embodiments, the statistical model is a multivariate model. In some embodiments, the statistical significance of the coefficient is computed as a p-value.

In some embodiments, the employing the statistical or numerical model comprises determining a potential association of one or more non-genetic factors and the S and D values with the one or more outcomes. In some embodiments, the statistical model is a GLM method and the one or more non-genetic factors to be associated with the phenotypic outcome or endpoint includes, but is not limited to, for example, clinical, demographic, environmental exposure factors, and combinations thereof. By way of a non-limiting example, in some embodiments, if the outcome is a phenotypic binary outcome such as, for example, having a disease or not having a disease, then one approach for statistical association can be to use logistic regression:

logit(Phenotype of subject j at marker i)=κᵢ+αᵢ*Sᵢⱼ+βᵢ*Dᵢⱼ+γᵢ*Sᵢⱼ*Dᵢⱼ+εᵢⱼ

or alternatively, in some embodiments the logistic regression can be:

logit(Phenotype of subject j at marker i)=κᵢ+αᵢ*Sᵢⱼ+βᵢ*Dᵢⱼ+εᵢⱼ

where Sᵢ and Dᵢ are the Sum and Difference of the normalized A and B allele measurements of intensity at marker i for subject j and εᵢⱼ is i.i.d. random error. In this case, αᵢ and βᵢ (and γᵢ if included) are estimated and determined whether to be statistically significantly different than 0. If so, then an association between the phenotype and the marker can be said to exist.

Accordingly, in some embodiments, the logistic regression model can be extended to include and account for other factors such as age as follows:

logit(Phenotype of subject j at marker i)=κᵢ+αᵢ*Sᵢⱼ+βᵢ*Dᵢⱼ+δᵢ*Ageᵢⱼ+εᵢⱼ

In some embodiments of the presently disclosed method for performing genomic marker association studies wherein allelic contrast and copy number are analyzed simultaneously, the method further comprises creating a matrix for the S values and for the D values, wherein the S values for each biological sample for each marker are ordered to be the columns of the S matrix and the markers are ordered to be the rows of the S matrix, and wherein the D values for each biological sample for each marker are ordered to be the columns of the D matrix and the markers are ordered to be the rows of the D matrix. One of ordinary skill in the art understands the ordering of matrices, and thus knows that the S or D matrix can be oriented such that the markers are ordered to be the columns and the S or D values are ordered to be the rows and still fall within the calculations of the present subject matter.

In some embodiments, the presently disclosed method comprises computing a singular value decomposition (SVD) for the S matrix and for the D matrix, wherein the SVD for the S matrix=U_{S} Σ_{S} V_{S}^{t} and the SVD for the D matrix=U_{D} Σ_{D} V_{D}^{t}, and wherein one or more diagonal values of the Σ_{D} and of the Σ_{S} that are associated with a dispersed nuisance effect are zeroed. In some embodiments, the presently disclosed method comprises computing a new sum value matrix (S′) and a new difference value matrix (D′), after the one or more diagonal values having dispersed effects are zeroed. That is, S′=U_{S} Σ′_{S} V_{S}^{t} and D′=U_{D} Σ′_{D} V_{D}^{t} where Σ′ indicates that certain nonzero diagonal values of E have been modified as zero (0). In some embodiments, the method comprises filtering the D′ matrix rows and the S′ matrix rows whose values either exceed a predetermined level of variability or fall below a predetermined level of invariability. Accordingly, advantages to the presently disclosed subject matter include the ability to uncover complicating and nuisance factors in a study that can be confounded with the phenotypic outcome, thereby reducing the potential for identifying false genetic associations.

In some embodiments, a method of the presently disclosed subject matter can comprise employing a full statistical model which includes the genetic terms S and D and nongenetic terms; and a reduced statistical model which only includes the nongenetic terms, wherein a statistically significant result comparing the full statistical model with the reduced statistical model indicates an association of the genetic terms with the outcome.

In some embodiments of the presently disclosed subject matter, a system is provided useful for performing genomic marker association studies wherein allelic contrast and copy number are analyzed simultaneously, comprising: a receiving module for receiving, for each marker, one or more measurements of intensity for each of two alleles (A and B) for each sample in a biological sample set; and a computing module for computing, for each marker, a sum value (S) and a difference value (D) of the intensities; and for employing, for each marker, a statistical or a numerical model to determine a potential association of the S and/or the D value with one or more outcomes of the biological sample set, wherein a statistically significant coefficient of the S intensity indicates an association of the copy number with the outcome and a statistically significant coefficient of the D intensity indicates an association of the allelic contrast with the outcome.

By way of a non-limiting example, an S value can be a sum of the intensities for the two alleles or a transformation of a sum and a D value can be a difference between the intensities for the two alleles or a transformation of a difference. As noted above, for each marker, a statistical or a numerical model can be employed to determine a potential association of the S and/or the D value with one or more outcomes of the biological sample set, wherein a statistically significant coefficient of the S intensity indicates an association of the copy number with the outcome and a statistically significant coefficient of the D intensity indicates an association of the allelic contrast with the outcome. In embodiments where an S and/or D value are a transformation, they are optionally a monotone transformation. For example, an S value can be computed as the logarithm of the sum of the intensities. Likewise, a D value can be computed as the log of the ratio of the intensities of each allele (log(A/B), In another example, such as for a dominant/recessive model, a transformation of a difference can be computed as f(log(A/B))=1 when log₂(A/B)>0.5, or when A/B>sqrt(2), and =0 otherwise. See also Examples 3, 6, and 8.

In some embodiments, the biological sample set comprises a binary outcome-type study, an ordinal outcome-type study, or a continuous outcome-type study. In some embodiments, the biological sample set is selected from a group including but not limited to a case versus control study, a subject cell versus matched cell study, and a tumor cell versus normal cell study.

In some embodiments, the computing module comprises normalizing the measurements of intensity. In some embodiments, the normalizing comprises normalizing the measurements of intensity to a reference distribution of measurements. In some embodiments, the measurements are intensity measurements of oligonucleotide probe hybridization signals. In some embodiments, the normalizing of the measurements is performed according to a method of quantile normalization, invariant set normalization, median centering normalization, or combinations thereof.

In some embodiments, the system comprises creating a matrix for the S values and for the D values, wherein the S values for each biological sample for each marker are ordered to be the columns of the S matrix and the markers are ordered to be the rows of the S matrix, and wherein the D values for each biological sample for each marker are ordered to be the columns of the D matrix and the markers are ordered to be the rows of the D matrix. One of ordinary skill in the art understands the ordering of matrices, and thus knows that the S or D matrix can be oriented such that the markers are ordered to be the columns and the S or D values are ordered to be the rows and still fall within the calculations of the present subject matter.

In some embodiments, the system comprises computing a singular value decomposition (SVD) for the S matrix and for the D matrix, wherein the SVD for the S matrix=U_{S} Σ_{S} V_{S}^{t} and the SVD for the D matrix=U_{D} Σ_{D} V_{D}^{t}, and wherein one or more diagonal values of the Σ_{D} and of the Σ_{S} that are associated with a dispersed nuisance effect are zeroed. In some embodiments, the system comprises computing a new sum value matrix (S′) and a new difference value matrix (D′), after the one or more diagonal values having dispersed effects are zeroed. In some embodiments, the system comprises filtering the D′ matrix rows and the S′ matrix rows whose values either exceed a predetermined level of variability or fall below a predetermined level of invariability.

In some embodiments, the statistical model is a model for binary outcomes. In some embodiments, the model for binary outcomes is a logistic regression model. In some embodiments, the statistical model is a general linear model. In some embodiments, the statistical model is a multivariate model. In some embodiments, the statistical significance of the coefficient is computed as a p-value.

In some embodiments, the system comprises employing the statistical or the numerical model comprises determining a potential association of one or more non-genetic factors and the S and D values with the one or more outcomes. In some embodiments, the factors are selected from the group including but not limited to clinical parameters, demographic data, environmental factors, and combinations thereof.

In some embodiments, the system can employ a full statistical model which includes the genetic terms S and D and nongenetic terms; and a reduced statistical model which only includes the nongenetic terms, wherein a statistically significant result comparing the full statistical model with the reduced statistical model indicates an association of the genetic terms with the outcome.

In some embodiments of the presently disclosed subject matter, a computer-readable medium is provided having stored thereon computer executable instructions that when executed by the processor of a computer perform steps comprising: receiving, for each marker, one or more measurements of intensity for each of two alleles (A and B) for each sample in a biological sample set; computing, for each marker, a sum value (S) and a difference value (D) of the intensities; and employing, for each marker, a statistical or a numerical model to determine a potential association of the S and/or the D value with one or more outcomes of the biological sample set, wherein a statistically significant coefficient of the S intensity indicates an association of the copy number with the outcome and a statistically significant coefficient of the D intensity indicates an association of the allelic contrast with the outcome.

By way of a non-limiting example, an S value can be a sum of the intensities for the two alleles or a transformation of a sum and a D value can be a difference between the intensities for the two alleles or a transformation of a difference. As noted above, for each marker, a statistical or a numerical model can be employed to determine a potential association of the S and/or the D value with one or more outcomes of the biological sample set, wherein a statistically significant coefficient of the S intensity indicates an association of the copy number with the outcome and a statistically significant coefficient of the D intensity indicates an association of the allelic contrast with the outcome. In embodiments where an S and/or D value are a transformation, they are optionally a monotone transformation. For example, an S value can be computed as the logarithm of the sum of the intensities. Likewise, a D value can be computed as the log of the ratio of the intensities of each allele (log(A/B), In another example, such as for a dominant/recessive model, a transformation of a difference can be computed as f(log(A/B))=1 when log_{2 (A/B)>}0.5, or when A/B>sqrt(2), and =0 otherwise. See also Examples 3, 6, and 8.

In some embodiments, the biological sample set comprises a binary outcome-type study, an ordinal outcome-type study, or a continuous (quantitative) outcome-type study. In some embodiments, the biological sample set is selected from a group including but not limited to a case versus control study, a subject cell versus matched cell study, and a tumor cell versus normal cell study.

In some embodiments, the computer executable instructions comprise normalizing the measurements of intensity. In some embodiments, the normalizing of each sample comprises normalizing the measurements of intensities to a reference distribution of measurements. In some embodiments, the measurements are intensity measurements of oligonucleotide probe hybridization signals. In some embodiments, the normalizing of the measurements is performed according to a method of quantile normalization, invariant set normalization, median centering normalization, or combinations thereof.

In some embodiments, the computer-readable instructions comprise creating a matrix for the S values and for the D values, wherein the S values for each biological sample for each marker are ordered to be the columns of the S matrix and the markers are ordered to be the rows of the S matrix, and wherein the D values for each biological sample for each marker are ordered to be the columns of the D matrix and the markers are ordered to be the rows of the D matrix. One of ordinary skill in the art understands the ordering of matrices, and thus knows that the S or D matrix can be oriented such that the markers are ordered to be the columns and the S or D values are ordered to be the rows and still fall within the calculations of the present subject matter. In some embodiments, the computer readable instructions comprise computing a singular value decomposition (SVD) for the S matrix and for the D matrix, wherein the SVD for the S matrix=U_{S} Σ_{S} V_{S}^{t} and the SVD for the D matrix=U_{D} Σ_{D} V_{D}^{t}, and wherein one or more diagonal values of the Σ_{D} and of the Σ_{S} that are associated with a dispersed nuisance effect are zeroed. In some embodiments, the computer readable instructions comprise computing a new sum value matrix (S′) and a new difference value matrix (D′), after the one or more diagonal values having dispersed effects are zeroed. In some embodiments, the computer readable instructions comprise filtering the D′ matrix rows and the S′ matrix rows whose values either exceed a predetermined level of variability or fall below a predetermined level of invariability.

In some embodiments, the statistical model is a model for binary, ordinal or continuous outcomes. In some embodiments, the model for binary, ordinal or continuous outcomes is a general linear model. In some embodiments, the general linear model is a logistic regression model. In some embodiments, the statistical model is a logistic regression model for binary outcomes. In some embodiments, the statistical model is a multivariate model. In some embodiments, the statistical significance of the coefficient is computed as a p-value.

In some embodiments, the computer-readable instructions comprise employing the statistical or the numerical model comprises determining a potential association of one or more non-genetic factors and the S and D values with the one or more outcomes. In some embodiments, the factors are selected from the group including but not limited to clinical parameters, demographic data, environmental factors, and combinations thereof.

In some embodiments, the computer-readable instructions comprise employing a full statistical model which includes the genetic terms S and D and nongenetic terms; and a reduced statistical model which only includes the nongenetic terms, wherein a statistically significant result comparing the full statistical model with the reduced statistical model indicates an association of the genetic terms with the outcome.

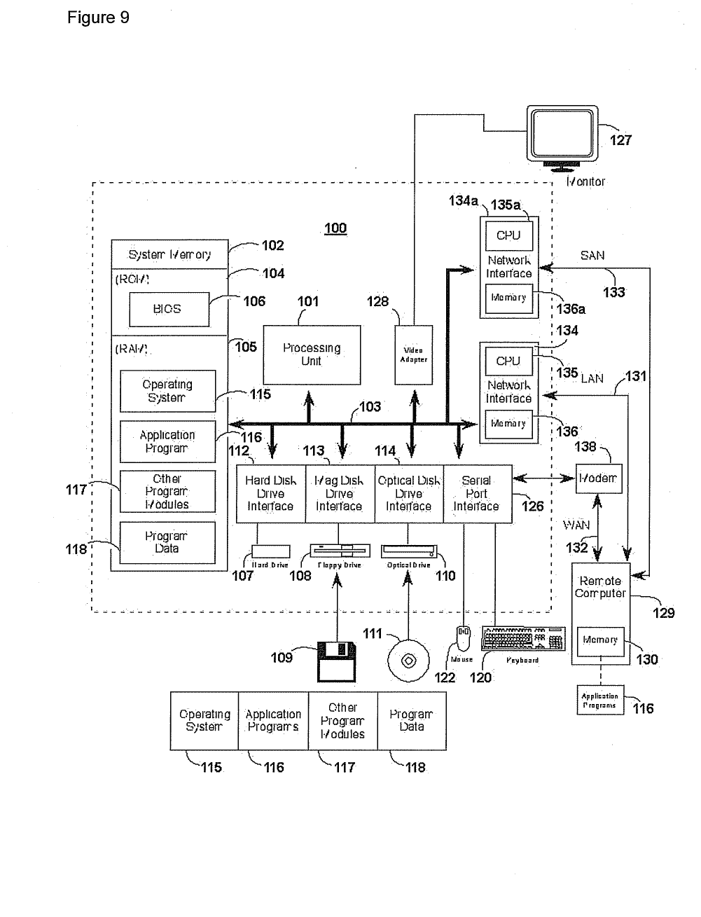

With reference to FIG. 9, an exemplary system for implementing the presently disclosed subject matter includes a general purpose computing device in the form of a conventional personal computer 100, including a processing unit 101, a system memory 102, and a system bus 103 that couples various system components including the system memory to the processing unit 101. System bus 103 can be any of several types of bus structures including a memory bus or memory controller, a peripheral bus, and a local bus using any of a variety of bus architectures. The system memory includes read only memory (ROM) 104 and random access memory (RAM) 105. A basic input/output system (BIOS) 106, containing the basic routines that help to transfer information between elements within personal computer 100, such as during start-up, is stored in ROM 104. Personal computer 100 further includes a hard disk drive 107 for reading from and writing to a hard disk (not shown), a magnetic disk drive 108 for reading from or writing to a removable magnetic disk 109, and an optical disk drive 110 for reading from or writing to a removable optical disk 111 such as a CD ROM or other optical media.

Hard disk drive 107, magnetic disk drive 108, and optical disk drive 110 are connected to system bus 103 by a hard disk drive interface 112, a magnetic disk drive interface 113, and an optical disk drive interface 114, respectively. The drives and their associated computer-readable media provide nonvolatile storage of computer readable instructions, data structures, program modules, and other data for personal computer 100. Although the exemplary environment described herein employs a hard disk, a removable magnetic disk 109, and a removable optical disk 111, it will be appreciated by those skilled in the art that other types of computer readable media which can store data that is accessible by a computer, such as magnetic cassettes, flash memory cards, digital video disks, Bernoulli cartridges, random access memories, read only memories, and the like can also be used in the exemplary operating environment.

A number of program modules can be stored on the hard disk, magnetic disk 109, optical disk 111, ROM 104, or RAM 105, including an operating system 115, one or more applications programs 116, other program modules 117, and program data 118. System memory 104 and/or 105 can also include a search engine, a database manager, and a comparator program having instructions for implementing the search, management, compilation (e.g. addition and deletion of data from database or other aspects of memory), comparing data, assessing data, and displaying the data and comparisons thereof. In one embodiment, database manager can include a software database application such as Oracle10g produced by Oracle Corporation of Redwood Shores, Calif., United States of America. Other software programs and packages are disclosed in the Examples.

A user can enter commands and information into personal computer 100 through input devices such as a keyboard 120 and a pointing device 122. Other input devices (not shown) can include those described herein above and below, as well as a microphone, touch panel, joystick, game pad, satellite dish, scanner, or the like. These and other input devices are often connected to processing unit 101 through a serial port interface 126 that is coupled to the system bus, but can be connected by other interfaces, such as a parallel port, game port or a universal serial bus (USB). A monitor 127 or other type of display device is also connected to system bus 103 via an interface, such as a video adapter 128. In addition to the monitor, personal computers typically include other peripheral output devices, not shown, such as speakers and printers. With regard to the presently disclosed subject the user can use one of the input devices to input data indicating the user's preference between alternatives presented to the user via monitor 127.

Personal computer 100 can operate in a networked environment using logical connections to one or more remote computers, such as a remote computer 129. Remote computer 129 can be another personal computer, a server, a router, a network PC, a peer device or other common network node, and typically includes many or all of the elements described above relative to personal computer 100, although only a memory storage device 130 has been illustrated in FIG. 9. The logical connections depicted in FIG. 14 include a local area network (LAN) 131, a wide area network (WAN) 132, and a system area network (SAN) 133. Local- and wide-area networking environments are commonplace in offices, enterprise-wide computer networks, intranets and the Internet.

System area networking environments are used to interconnect nodes within a distributed computing system, such as a cluster. For example, in the illustrated embodiment, personal computer 100 can comprise a first node in a cluster and remote computer 129 can comprise a second node in the cluster. In such an environment, it is preferable that personal computer 100 and remote computer 129 be under a common administrative domain. Thus, although computer 129 is labeled “remote”, computer 129 can be in close physical proximity to personal computer 100.

When used in a LAN or SAN networking environment, personal computer 100 is connected to local network 131 or system network 133 through network interface adapters 134 and 134a. Network interface adapters 134 and 134a can include processing units 135 and 135a and one or more memory units 136 and 136a.

When used in a WAN networking environment, personal computer 100 typically includes a modem 138 or other device for establishing communications over WAN 132. Modem 138, which can be internal or external, is connected to system bus 103 via serial port interface 126. In a networked environment, program modules depicted relative to personal computer 100, or portions thereof, can be stored in the remote memory storage device. It will be appreciated that the network connections shown are exemplary and other approaches to establishing a communications link between the computers can be used.

The subject matter described herein for performing genomic marker association studies wherein allelic contrast and copy number are analyzed simultaneously can be implemented in hardware, software, firmware, or any combination thereof. As such, the term “module” as used herein refers to hardware, software, and/or firmware for implementing the feature being described. In one exemplary implementation, the subject matter described herein can be implemented using a computer readable medium having stored thereon computer executable instructions that when executed by the processor of a computer perform steps of the aforementioned methods (see above). Exemplary computer readable media suitable for implementing the subject matter described herein includes disk memory devices, programmable logic devices, and application specific integrated circuits. In one implementation, the computer readable medium can include a memory accessible by a processor. The memory can include instructions executable by the processor for implementing any of the methods for performing genomic marker association studies wherein allelic contrast and copy number are analyzed simultaneously as described herein. In addition, a computer readable medium that implements the subject matter described herein can be located on a single device or computing platform or can be distributed across multiple physical devices and/or computing platforms.

### EXAMPLES

The following Examples have been included to illustrate modes of the presently disclosed subject matter. In light of the present disclosure and the general level of skill in the art, those of skill will appreciate that the following Examples are intended to be exemplary only and that numerous changes, modifications, and alterations can be employed without departing from the scope of the presently disclosed subject matter.

### Example 1

### Analysis of S and D Allele Signal Intensities Between Subjects Having Distinct Phenotypes

A straightforward and robust method for analyzing genetic data for phenotypic association was performed as follows. For each genomic marker, alleles are generically referred to herein as A and B. Signal intensity measurements were generated for A allele and B allele signals, and copy number and allelic contrast values were calculated from the intensity measurements and plotted as shown in FIGS. 5a-5b (FIG. 5a shows data for phenotype 1 and FIG. 5b shows data for phenotype 0). Rather than restricting the model to the assumption that there can be only two copies of the allelic marker per locus, in this example, a multi-state model of genotype was assumed as shown in FIGS. 3 and 4. The axes in FIG. 4 are shown superimposed on the multiple genotypic states, illustrating that genotypic state can be viewed equivalently as copy number ordered pairs of A and B or as sum and difference ordered pairs of A+B and A−B. The integer labels in FIG. 4 are theoretical.

Specifically, in this Example normalized signal intensities for 80 subjects having phenotype 0 and 80 subjects having phenotype 1 were artificially generated to simulate observed data for two alleles (A and B) at one locus. For the 80 subjects having phenotype 1, 100 alleles of type A were assigned, most having one copy but some having zero, two, and even three copies of A. Also 70 copies of B were assigned to the 80 subjects so that most subjects had exactly two copies total of A and/or B. However, eleven subjects had exactly three copies total of A and/or B and one subject had only one copy of the alleles. For the 80 subjects having phenotype 0, alleles A and B were assigned randomly so that each allele had the same frequency and all subjects had two copies total of A and/or B.

Each instance of an allele was assigned the equivalent in a signal intensity of 1±0.2 (stdev using normal distribution) units. To simulate the traditional approach to GWAS analysis, each subject was then assigned one of the three traditional genotypic states (AA, AB, BB) based on relative intensity of A versus B. The p-value for the traditional Armitage linear trend test assuming three states was 0.58. However, for the new methods disclosed herein, allele intensities were left in their raw form and the Sum (S) and Difference (D) value between the allele intensities was computed. The p-value for the Difference term in a logistic regression using the original intensity data was much less (0.28) than the linear trend test and the p-value for the Sum term indicating copy number variants had a p-value of 0.08. FIG. 5a shows a plot of the sum versus difference values for subjects having phenotype 1. FIG. 5b shows a plot of the sum versus difference values for a collection of subjects having phenotype 0. The sum and difference values are indicated by the dark diamond-shaped points.

Looking at FIGS. 5a-5b, it is apparent that the majority of the data points fall more or less into three separate clusters. However, a significant minority of the data points cannot be readily assigned to any one of the three clusters. In any case and unlike the traditional approach, the currently exemplified method does not depend on having a genotypic classification of each data point to determine if there are significant differences between the two phenotypes based on allelic content.

In contrast to the traditional approach, in the current Example, a determination was made as to whether a shift occurred in the center of mass of the sum and difference values between subjects having distinct phenotypes. This is illustrated in FIGS. 5a-5b, where the circle-shaped points indicate the center of mass for the sum and difference points. In FIG. 5a, there is an observed horizontal shift to the right on the difference axis of the circle-shaped point representing the center of mass. Assuming the observed shift to the right on the difference axis is statistically significant, the shift indicates an association between a relative increase in the proportion of A allele and the phenotype 1. In FIG. 5b, the shift to the right of the circle-shaped point representing the center of mass is less noticeable, indicating a potentially lesser association or no association between the phenotype 0 and an increase in the A allele.

### Example 2

### Employment of a Statistical Model to Determined an Association of Outcome with S and D Values

A range of statistical and/or numerical models can be employed to determine whether there is a statistical association between the phenotypic outcomes 1 and 0 described in the Example above, and either the sum values or the difference values or both. In one approach, a general linear model (GLM) method can be employed which supports the binary phenotypic outcomes 1 and 0. In particular, the GLM that can be used is a logistic regression as follows:

logit(Phenotype of subject j at marker i)=κᵢ+αᵢ*Sᵢⱼ+βᵢ*Dᵢⱼ+γᵢ*Sᵢⱼ*Dᵢⱼ+εᵢⱼ

or alternatively the GLM that can be used is a logistic regression as follows:

logit(Phenotype of subject j at marker i)=κᵢ+αᵢ*Sᵢⱼ+βᵢ*Dᵢⱼ+εᵢⱼ

where Sᵢ and Dᵢ are the sum and difference of the normalized A and B allele signals at genetic marker i for subject j and is i.i.d. random error. In this case, αᵢ and βᵢ (and γᵢ if included) can be estimated and a determination made as to whether there is a statistically significant difference from 0. If so, then an association between the phenotype and the marker can be said to exist.

In another approach, a GLM method can be employed to allow for additional factors to be correlated or associated with the phenotype outcomes 1 and 0 such as, for example, age. In this form, the logistic regression model can be easily extended to include and account for the additional factor age as follows:

logit(Phenotype of subject j at marker i)=κᵢ+αᵢ*Sᵢⱼ+βᵢ*Dᵢⱼ+δᵢ*Ageᵢⱼ+εᵢⱼ

Accordingly, one of the advantages to the approach described in Examples 1 and 2 is the ability to eliminate complicating artifacts due to measurement error and batch and population effects. Such artifacts can result in false positives such as an incorrect genetic association with a phenotype or false negatives where an actual genetic association is overlooked. The presently disclosed subject matter provides an alternative approach for measuring allelic copy number association in genome-wide association studies. In addition, allelic contrast and copy number are measured simultaneously in the genomic association studies.

### Example 3

### Modeling of Sum and Difference of Allele-Specific Copy Number in HapMap Data

The presently disclosed methods for performing genomic marker association studies wherein allelic contrast and copy number are analyzed simultaneously were tested using data from The International HapMap Consortium. For the test experiment described in this Example, the sum and difference of the allele-specific copy number were simultaneously modeled. The sum and difference calculations were performed in the same manner as described above in Examples 1 and 2, wherein the copy number, i.e. sum value, is the total allele count and was calculated by summing the A allele intensity and the B allele intensity, and the allelic contrast, i.e. difference value, is the difference in allele sequence and was calculated by subtracting the A allele intensity from the B allele intensity.

The goal of the International HapMap Consortium (2003) from which the test data was taken is to catalog common patterns of human genetic variation. As part of the process, the HapMap Consortium profiled 270 individuals from four distinct populations. The populations included the Yoruba people in Ibadan, Nigeria (30 both parent and adult child trios; 90 total samples), the Japanese people in Tokyo (45 unrelated individuals), the Han Chinese people in Beijing (45 unrelated individuals), and the CEPH people (30 trios; 90 total samples). The HapMap Consortium project provided a large amount of information regarding the genetic diversity and relationships of these populations. The HapMap Consortium findings included specific reports on the naturally occurring genetic differences between the populations, including a report that the Yoruban population demonstrates the most distinct genetic structure (see The International HapMap Consortium, 2007).

The goal of the present Example was to determine if traditional GWAS results of HapMap Consortium data analysis could be duplicated using the presently disclosed methods of performing GWAS where allelic contrast and copy number are tested simultaneously for a potential phenotypic association. In addition, in the present Example, the representations of the allelic intensity measurements are continuous (quantitative) and do not require that each data point be categorized as a particular genotype.

The intensity measurements for the allelic markers in the 270 HapMap samples used in the current Example were obtained by a number of assay systems including the Affymetrix Genome-Wide Human SNP Array version 6.0. The Affymetrix device can be used to assay approximately 1.8 million genetic markers to measure allele specific and regional copy number. These data are publicly available and were obtained directly from Affymetrix. In the current Example, the measurement intensity signals for the allele-specific probes were estimated using Affymetrix Genotyping Console (version 2.1).

Briefly, quantile normalization and log transformation of the raw data was performed also using Affymetrix Genotyping Console. The normalized and transformed values were then used to fit a linear model for estimation of chip and probe effects. The estimation of chip and probe effects was performed separately for each allele at each marker location. The process resulted in summary measurements of intensity for the two alleles (A and B) at each marker location.

The summary measurements for the A and B alleles in a given sample were combined by calculating a sum value (A+B) and a difference value (A−B) for each marker. The resulting two matrices are herein referred to as the S (sum) and D (difference) matrices, respectively. In this transformation, S provides a copy number estimate, calculated by summing the A allele intensity and the B allele intensity, and D provides an allelic contrast estimate, and was calculated by subtracting the A allele intensity from the B allele intensity. The S and D values were then tested for association with a phenotype in the framework of a general linear model (GLM). For example, letting Y denote a binary phenotype (Yoruban or non-Yoruban) of subject j, and letting i represent a marker, model 1 was fit using logistic regression with the following model:

Yⱼ=βᵢ₀+βᵢ₁*Sᵢⱼ+βᵢ₂*Dᵢⱼ+εᵢⱼ (1)

The resulting estimated coefficients, \hat{β}ᵢ₁ and \hat{β}ᵢ₂, were used to determine if a significant proportion of variation in the phenotype is explained by the copy number value (\hat{β}ᵢ₁) or the allelic contrast value (\hat{β}ᵢ₂) or both. This was achieved by calculating test statistics and associated p-values for the coefficients of the copy number and allelic contrast values. The p-values were filtered to arrive at significant associations with the Yoruban population.

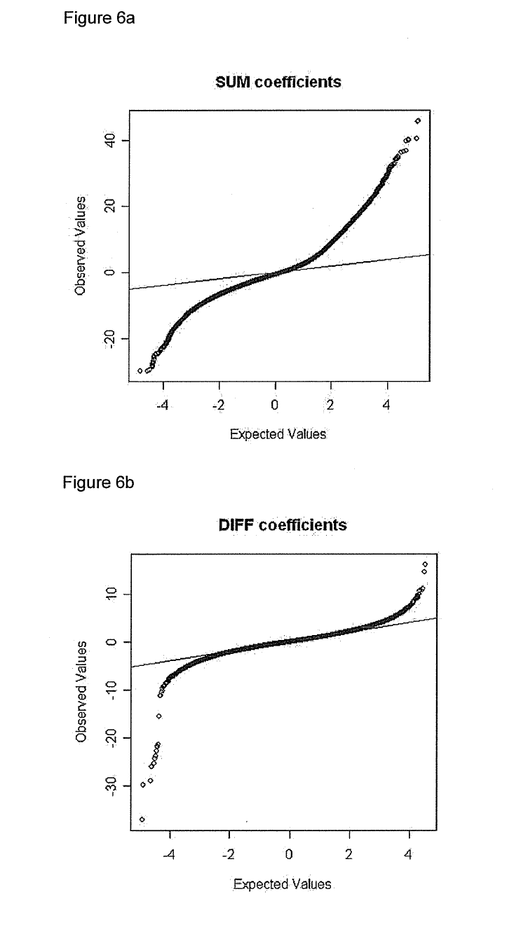

Application of the logistic model above resulted in a large number of significant associations attributable to both copy number association and allelic contrast association. The results are shown in quantile-quantile plots of coefficients of the expected versus the observed S values (SUM) and D values (DIFF) (see FIGS. 6a-6b). The extreme variation in the coefficients at the tail ends in both plots shown in FIGS. 6a and 6b show significant deviation from the expected line, indicating the presence of numerous markers having scores significantly higher than expected due to chance alone. These results are consistent with expectations given that the phenotype being tested is ethnic heritage, a trait determined by genetics. For example, the HapMap Consortium project and others have previously reported the large number of differences in allelic variation that was observed in this study. Therefore, the results reported herein provide that changes in the S and D matrices as described herein can be used in lieu of discrete genotype and copy number calls.

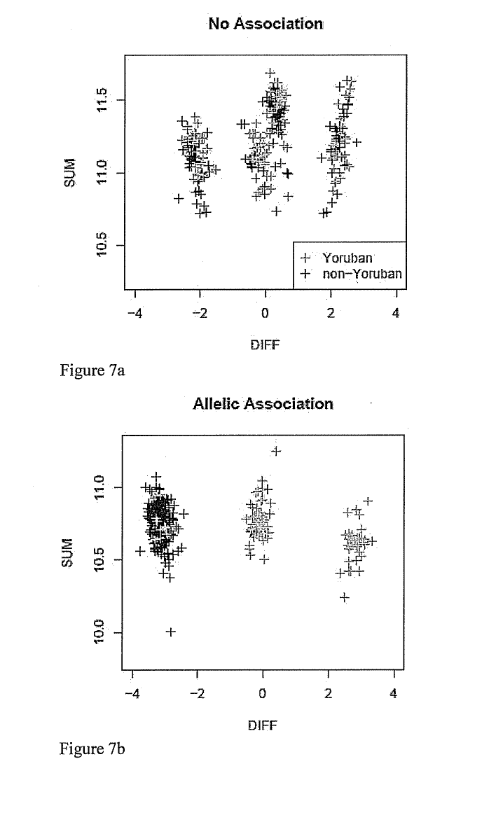

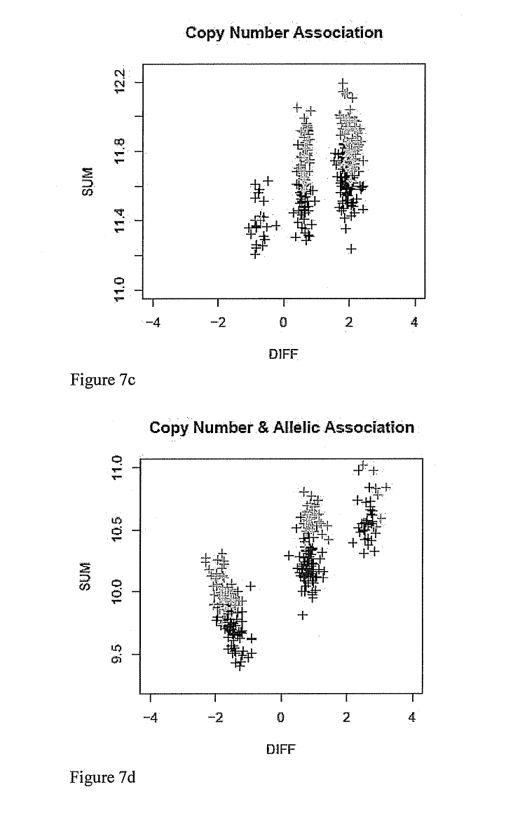

The S and D values from were plotted for four representative markers as shown in FIGS. 7a-7d. FIGS. 7a-7d are scatter plots of S values (SUM) versus D values (DIFF) for measurements of a single marker across each of the 270 HapMap samples for a Yoruban (grey crosses) and a non-Yoruban (black crosses) population. Each of the graphs in FIGS. 7a-7d depicts the S and D values for a separate marker.

The data shown in FIGS. 7a-7d are representative markers showing the four possible allele association states as follows: 1) neither the copy number SUM values nor the allelic contrast DIFF values show a significant association with phenotype (see FIG. 7a where p>0.1 for both terms); 2) only the allelic contrast DIFF values show a significant association with phenotype (see FIG. 7b where p>0.1 for SUM and p<0.01 for DIFF); 3) only the copy number SUM values show a significant association with phenotype (see FIG. 7c where p<0.01 for SUM and p>0.1 for DIFF); and 4) both the copy number SUM values and the allelic contrast DIFF values show a significant association with phenotype (see FIG. 7d where p<0.01 for SUM and DIFF).

The data shown in FIGS. 7a-7d demonstrate the utility of the presently disclosed subject matter for performing genomic marker association studies wherein allelic contrast and copy number are analyzed. For example, in the present Example the markers in the Yoruban population known to be associated with copy number demonstrated a clear shift in SUM values for the Yoruban versus non-Yoruban (see FIGS. 7b & 7d). Similarly, the Yoruban markers known to be associated with an allele demonstrated a shift on the DIFF axis (see FIGS. 7c & 7d).

### Example 4

### Visualization of Genome-Wide Associations with Respect to Chromosome Location for HapMap Samples

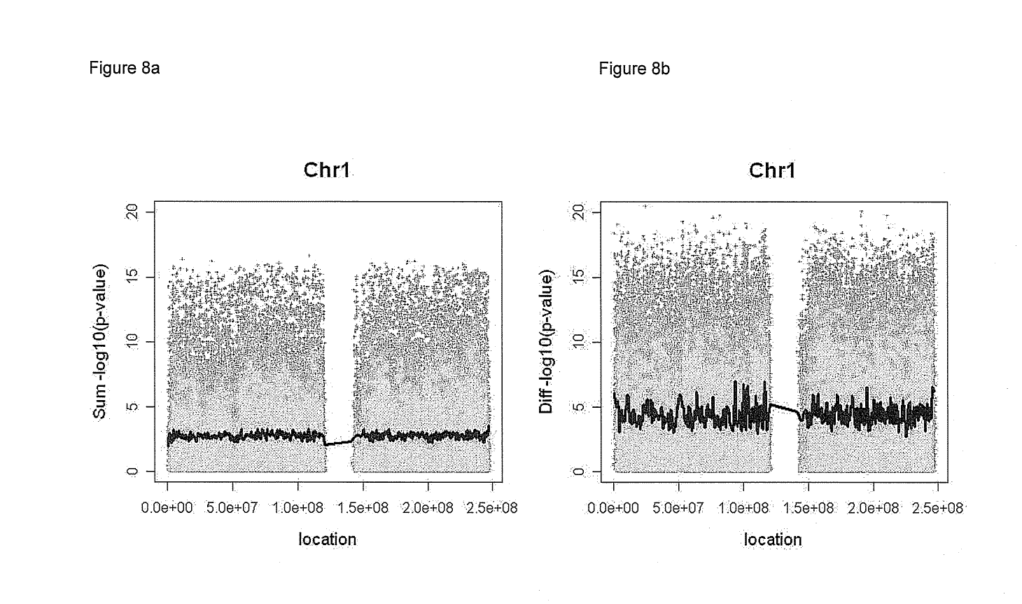

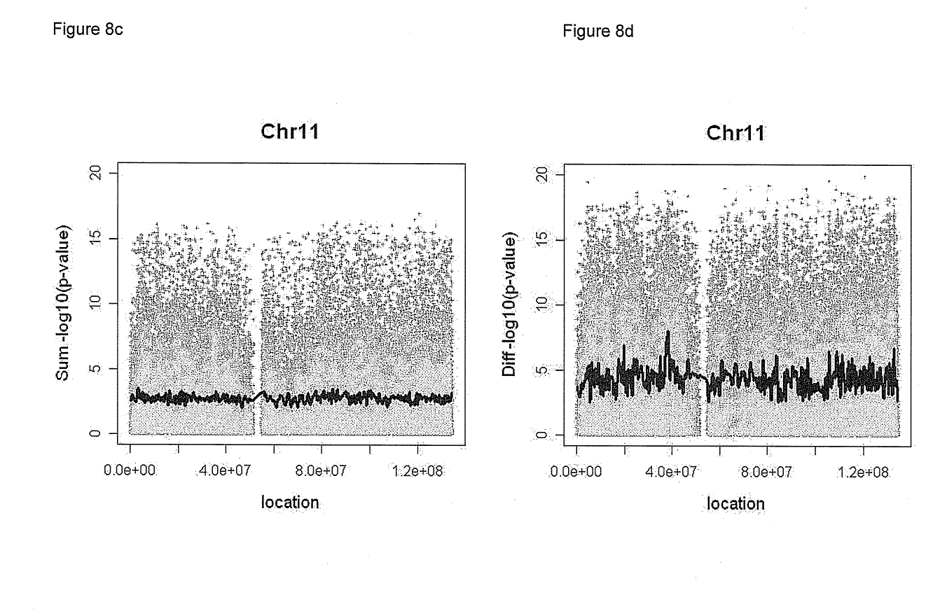

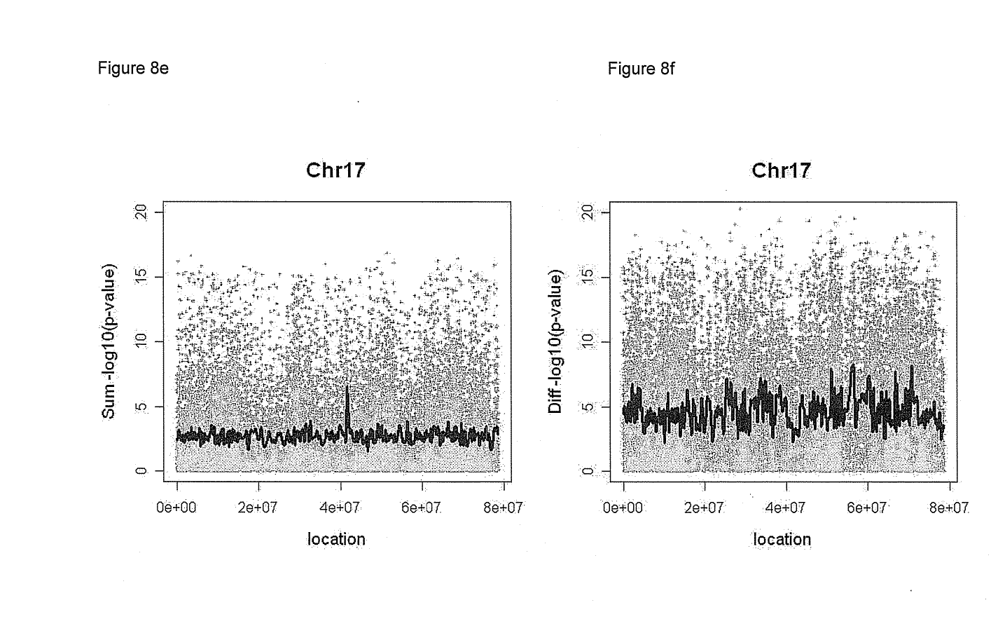

In addition to looking at population associations with allele-specific copy number and allele contrast, the HapMap Consortium data were also analyzed in order to visualize genome wide associations with respect to genome location (see FIGS. 8a-8f). FIGS. 8a-8f are plots of p-values for coefficients of Sum values (FIGS. 8a, 8c & 8e) and Diff values (FIGS. 8b, 8d & 8f) plotted by location in the genome for representative chromosomes. The scatter in the p-values (gray points) indicates the extreme p-values measured throughout the genome. Patterns of sustained higher p-values resulting after Loess smoothing of the raw p-values (dark lines) identify regions in the chromosome of associations between copy number (Sum graphs) and allele contrast (Diff graphs). FIGS. 8a & 8b are plots of p-value coefficients for sum values (FIG. 8a) and difference values (FIG. 8b) plotted by location in the genome for chromosome 1. FIGS. 8c & 8d are plots of p-value coefficients for sum values (FIG. 8c) and difference values (FIG. 8d) plotted by location in the genome for chromosome 11. FIGS. 8e & 8f are plots of p-value coefficients for sum values (FIG. 8e) and difference values (FIG. 8f) plotted by location in the genome for chromosome 17.

In summary, a logistic model was employed in the presently disclosed methods to identify population associations in the HapMap Corsortium data with allele-specific copy number and allelic contrast. As expected, use of the presently disclosed subject matter identified an overwhelming number of genetic associations with population. Based on these and other data, it is concluded that the present methods can be employed to identify genome-wide allelic contrast and copy number associations while allowing a simple and rapid workflow. In addition, the presently disclosed methods are amenable to use with a wide range of phenotypic endpoints and experimental designs.

### Example 5

### Simultaneous Analysis of Copy Number and Allelic Contrast in GWAS of Wellcome Trust Samples

The Wellcome Trust Datasets are GWAS datasets that are publicly available after the recent publication of the 2007 Nature (The Wellcome Trust Case Control Consortium) paper. The Wellcome Trust studies were initially designed with ˜2000 case subjects for each of seven diseases, including rheumatoid arthritis, type 1 diabetes, and Crohn's disease. Along with the case subjects were a set of ˜3000 common control subjects. The publicly available dataset provides fewer than ˜2000 control subjects. However, this is still a powerful dataset even with the fewer publicly available control subjects. The individuals selected for the study were living in England, Scotland and Wales and self-identified themselves as being of white European ancestry. In the end, approximately 800 individuals were removed from the study due to contamination, false identity, non-Caucasian ancestry, and relatedness. Genetic variation for all of the approximately 14,000 subjects in the dataset was measured. In the study, Affymetrix SNP arrays were used to measure roughly 500,000 loci for each of the approximately 14,000 subjects. A new algorithm was developed for the study called CHIAMO to determine genotypes for all individuals using the standard assumptions. No copy number analysis was published in the initial study.

In the present Example, many of the findings of the Wellcome Trust Study can be replicated using the presently disclosed subject matter. For example, the presently disclosed methods can be used to confirm the identification of SNPs associated with disease. In addition, new SNPs associated with disease can be identified that might have been overlooked in the initial study due to error in assignment of genotypic state. Finally, the presently disclosed analysis methods can also be employed to simultaneously identify copy number variants associated with the disease.

Specifically, in the present Example, signal intensities from the A and B alleles from the Affymetrix 500k SNP system can be received (after probe normalization) and the Sum (S) and Difference (D) for each SNP can be computed. A S matrix and a D matrix can be created for the S and D values where SNPs are represented in rows and samples are represented in columns. Optionally, nuisance variation due to technical and sub-population effects can be reduced by computing a singular value decomposition (SVD) for the S matrix and for the D matrix, wherein the SVD for the S matrix=U_{S} Σ_{S} V_{S}^{t} and the SVD for the D matrix=U_{D} Σ_{D} V_{D}^{t}, and wherein one or more diagonal values of the Σ_{D} and of the Σ_{S} that are associated with a dispersed nuisance effect are zeroed. Optionally, a new sum value matrix (S′) and a new difference value matrix (D′) can be computed, after the one or more diagonal values having dispersed effects are zeroed. Optionally, the D′ matrix rows and the S′ matrix rows can be filtered that either exceed a predetermined level of variability or fall below a predetermined level of invariability.

Next, statistically significant coefficients of a logistic regression model can be estimated and determined by employing the model, for each marker, to determine a potential association of the S and/or the D value with one or more outcomes of the biological sample set, wherein a statistically significant coefficient of the S intensity indicates an association of the copy number with the outcome and a statistically significant coefficient of the D intensity indicates an association of the allelic contrast with the outcome. In the logistic regression model, the outcome can be binary (e.g. disease/no disease) and the inputs are the S and D values for a particular SNP. The p-values associated with the coefficients can be set at a stringent level (10⁻⁰⁷ or lower) depending on prior information (i.e. obtained prior to the Wellcome Trust Study). In addition, adjacent SNP markers that have a consistently smaller p-value but not at the 10⁻⁰⁷ level can also be noted. Follow-up analysis can include analyzing which genes are located near a SNP identified as having an association to determine whether there are genomic pathways that can be implicated.

### Example 6

### Ambiguity and Missing Values (‘No Calls’) in GWAS

Actual data from a GWAS of roughly 1300 subjects were analyzed. The subjects' DNA was assayed with an Illumina 1M-Duo microarray, a device that allows for simultaneous measurement of over one million SNPs.

From FIG. 10, we see examples of functions of total intensity, R, versus the angle θ of intensity of A allele vs. B allele, wherein R=log(A allele intensity+B allele intensity). The angle θ is one example of a transformation of the allelic contrast (equivalent to tan⁻¹(allele A/allele B)).

### Example 7

### Reproducibility of Cancer Genetic Markers of Susceptibility (CGEMS) GWAS Results

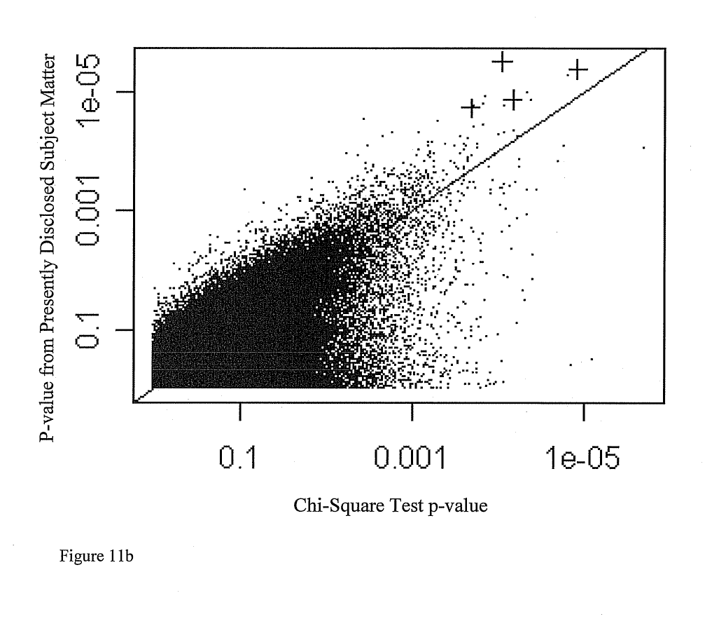

The presently disclosed subject matter for performing genomic marker association studies was applied to two of the CGEMS datasets (Yeager et al. and Hunter et al. (2007)). The results from the breast cancer study are presented here. The CGEMS breast cancer study involved genotyping over 1100 postmenopausal women with invasive breast cancer and a similar number of matched controls from the Nurses' Health Study (Hunter et al. (2007)). The Illumina Hap550 SNP microarray was used to measure genotypic information. For this study, the presently disclosed subject matter successfully reproduced the Fibroblast Growth Factor Receptor 2 (FGFR2) region that was found to be highly associated with late-onset breast cancer (FIG. 11a). This association did not require genotype calling. Moreover, when the significance of the p-value of the presently disclosed subject matter was examined in comparison to significance values reported for the FGFR2 SNPs, the p-value of the presently disclosed subject matter was typically smaller (more significant) than p-value with the χ² test (both p-values were adjusted for potential subpopulation bias). See FIG. 11b.

### Example 8

### Power of the Simultaneous Analysis of Allelic Contrast and Copy Number

Using the original normalized intensity data for association analysis is very similar to using the genotype calls. In fact, logistic regression using the allelic intensity contrast is statistically equivalent to the Cochran-Armitage trend test when there is no measurement or classification error. Bifurcation of the allelic contrast intensity data for dominant/recessive testing is also equivalent to the Cochran-Armitage trend test.

A simulation of truly associated SNPs having a linear trend in the probability of allele association with phenotype was created. The experimental design included a grid of parameter values each randomly sampled ten times (Monte Carlo fashion) wherein the resulting p-values were averaged (geometric) over the ten Monte Carlo trials. The parameters were selected based on their importance to GWAS design. Then p-values of the presently disclosed subject matter were compared to p-values from other common statistical tests used in GWAS: the Cochran-Armitage linear trend test; Cochran-Mantel-Haenszel general association test; and the χ² test (classical and likelihood ratio). The actual values of the parameters composing the grid included: penetrance (10%-70% by 5%), minor allele frequency (MAF) (5%-40% by 5%), variation in probe signal (coefficient of variation or CV=5%-25% by 5%) and sample size (1000-3000 by 1000) split evenly in a case-control fashion. The parameter values were chosen either because they are commonly specified in GWAS (e.g., sample size and MAF) or because they are typically observed (CV of probe signal, penetrance of risk allele).

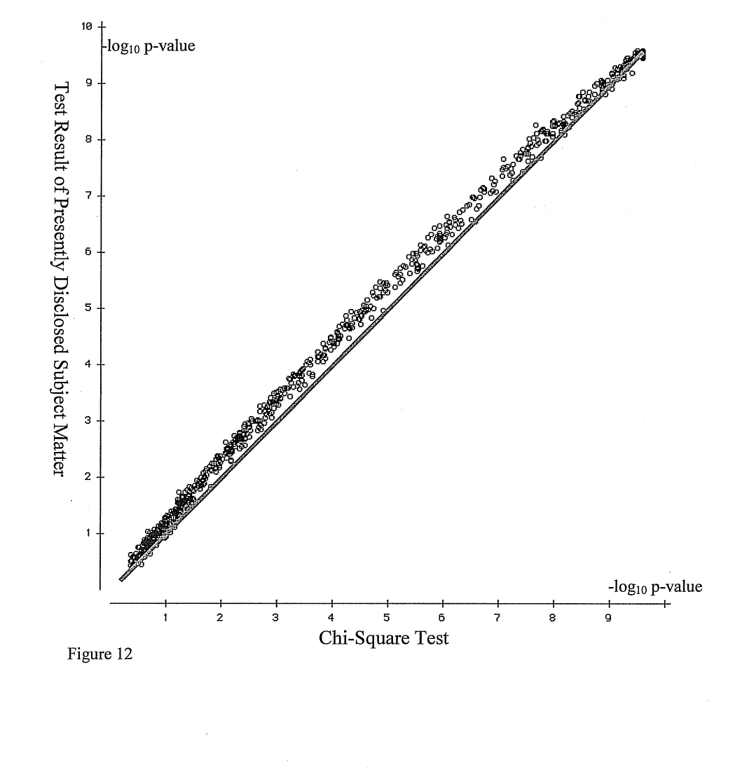

The (−log₁₀) p-value of the approach of the presently disclosed subject matter was directly compared to the (−log₁₀) p-value from standard approaches with results provided in a series of figures. In FIG. 12, we compare the results from the simulation using the presently disclosed subject matter with results from a classical χ² test. Smaller p-values indicated a result that is less likely due to chance. To better illustrate the magnitudes of the p-values, a −log₁₀ transformation was performed so that increasing −log₁₀ p-values were more significant (and corresponded to smaller p-values). With the result from the presently disclosed subject matter on the y-axis and the classical two degrees-of-freedom χ² test on the x-axis, we see the result of the presently disclosed subject matter almost always outperforms the classical test over the range of values of the grid, but especially as sample size is close to 2000 for a variety of penetrance and MAF values. This is not too surprising given that the classical χ² test has two degrees of freedom while the result of the presently disclosed subject matter has approximately one degree of freedom (due to the linearity assumption in allele risk). Nevertheless, the classical χ² test is a robust test that is frequently used.

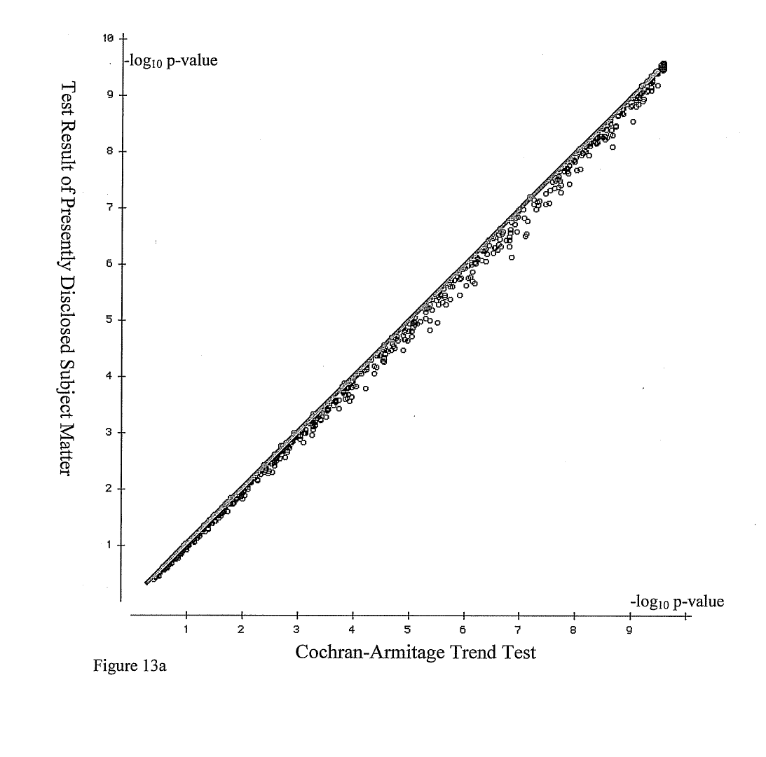

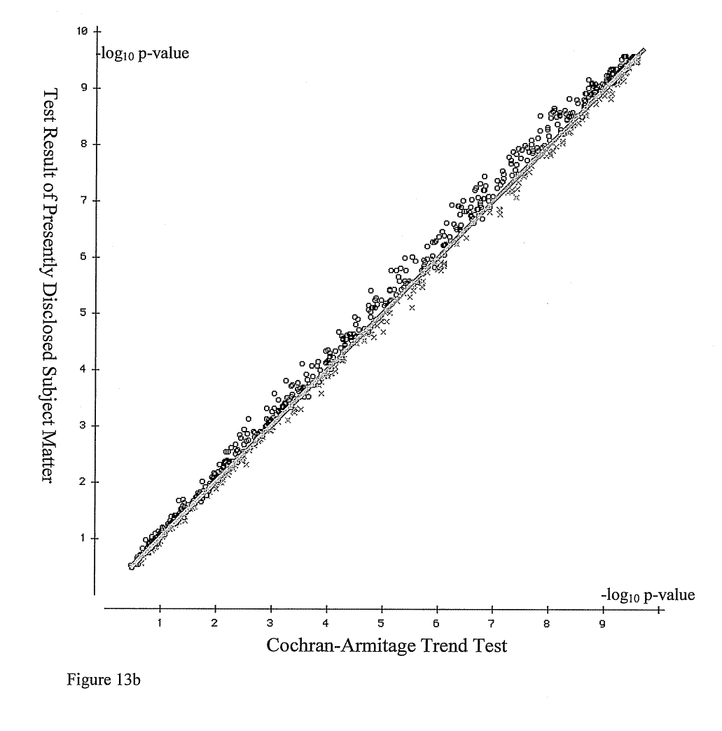

In FIG. 13a, we see that the results using the presently disclosed methods are roughly equivalent (and monotonic) to the Cochran-Armitage test as suggested by theory. In this case, a scenario was deliberately created such that a one degree of freedom test was compared to another in a manner where there were few missing genotype calls (due to smaller CV values used and no copy number variation present). Since there were no copy number variants in this particular simulation, the idea of conforming each cluster to one of three genotypes made sense and measurement error was reduced, giving a slight advantage to the Cochran-Armitage test with called genotypes. On the other hand, when CNV is inserted at modest amounts into the simulation, the presently disclosed methods have more power (FIG. 13b). This is not surprising as the presence of CNV often yields subjects who will fall “between” primary genotype clusters (e.g., AAB rather than AA or AB) frequently resulting in no-calls (loss-of-data) for these samples.

Since the presently disclosed subject matter works robustly whether CNVs are present or not, there is no need to be concerned whether CNVs are present if the tests are performed using the presently disclosed methods. Highly significant SNPs that follow the Cochran-Armitage assumptions will show similar significance with the presently disclosed subject matter. If CNVs are present for a given subject at a locus interrogated by a SNP, the presently disclosed subject matter will accommodate the allele intensity changes created by the CNV while the standard method will frequently result in the subjects being culled from the study due to their allele's propensity for being genotypically classified as a ‘no call’ as a result of the ambiguity in genotypic state that the CNV creates.

### REFERENCES

All references cited in the specification, including but not limited to U.S. and foreign patents and patent application publications, scientific journal articles, and database entries (including all annotations presented therein), are incorporated herein by reference to the extent that they supplement, explain, provide a background for or teach methodology, techniques and/or compositions employed herein.
1. Rabbee, N., et al. A genotype calling algorithm for Affymetrix SNP arrays. Bioinformatics 22:7-12 (2006).
2. The International HapMap Consortium. The International HapMap Project. Nature 426:789-796 (2003).
3. The International HapMap Consortium. A second generation human haplotype map of over 3.1 million SNPs. Nature. 449:851-61 (2007).
4. Wang K., et al. PennCNV: an integrated hidden Markov model designed for high-resolution copy number variation detection in whole-genome SNP genotyping data Genome Research 17:1665-1674, (2007).
5. The Wellcome Trust Case Control Consortium. Genome-wide association study of 14,000 cases of seven common diseases and 3,000 shared controls. Nature 447:661-678 (2007).
6. Wellcome-Trust Case-Control Consortium, Nature, 447, 661-678, (2007).
7. Yeager et al., Nature Genetics 39(5), 645-649 (2007).
8. Hunter et al., Nature Genetics 39(7), 870-874 (2007).

It will be understood that various details of the subject matter disclosed herein can be changed without departing from the scope of the presently disclosed subject matter. Furthermore, the foregoing description is for the purpose of illustration only, and not for the purpose of limitation.

What is claimed is:

1. A method of performing genomic marker association studies wherein allelic contrast and copy number are analyzed simultaneously, the method comprising:
receiving, for each marker, one or more measurements of intensity for each of two alleles (A and B) for each sample in a biological sample set;
computing, for each marker, a sum value (S) and a difference value (D) of the intensities; and
employing, for each marker, a statistical or a numerical model to determine a potential association of the S and/or the D value with one or more outcomes of the biological sample set, wherein a statistically significant coefficient of the S intensity indicates an association of the copy number with the outcome and a statistically significant coefficient of the D intensity indicates an association of the allelic contrast with the outcome.

2. The method of claim 1, wherein the biological sample set comprises a binary outcome-type study, an ordinal outcome-type study, or a continuous outcome-type study.

3. The method of claim 2, wherein the biological sample set is selected from a group consisting of a case versus control study, a subject cell versus matched cell study, and a tumor cell versus normal cell study.

4. The method of claim 1, comprising normalizing the one or more measurements of intensity.

5. The method of claim 4, wherein the normalizing comprises normalizing the one or more measurements of intensities to a reference distribution of measurements.

6. The method of claim 4, wherein the measurements are intensity measurements of oligonucleotide probe hybridization signals.

7. The method of claim 6, wherein the normalizing of the measurements is performed according to a method of quantile normalization, invariant set normalization, median centering normalization, or combinations thereof.

8. The method of claim 1, comprising creating a matrix for the S values and for the D values, wherein the S values for each biological sample for each marker are ordered to be the columns of the S matrix and the markers are ordered to be the rows of the S matrix, and wherein the D values for each biological sample for each marker are ordered to be the columns of the D matrix and the markers are ordered to be the rows of the D matrix.

9. The method of claim 8, comprising computing a singular value decomposition (SVD) for the S matrix and for the D matrix, wherein the SVD for the S matrix=U_{S} Σ_{S} V_{S}^{t} and the SVD for the D matrix=U_{D} Σ_{D} V_{D}^{t}, and wherein one or more diagonal values of the Σ_{D} and of the Σ_{S} that are associated with a dispersed nuisance effect are zeroed.

10. The method of claim 9, comprising computing a new sum value matrix (S′) and a new difference value matrix (D′), after the one or more diagonal values having dispersed effects are zeroed.

11. The method of claim 10, comprising filtering the D′ matrix rows and the S′ matrix rows that either exceed a predetermined level of variability or fall below a predetermined level of invariability.

12. The method of claim 1, wherein the statistical model is a model for binary, ordinal or continuous outcomes.

13. The method of claim 12, wherein the model for binary, ordinal or continuous outcomes is a general linear model.

14. The method of claim 13, wherein the general linear model is a logistic regression model.

15. The method of claim 14, wherein the logistic regression model is a model for binary outcomes.

16. The method of claim 1, wherein the statistical model is a multivariate model.

17. The method of claim 1, wherein the statistical significance of the coefficient is computed as a p-value.

18. The method of claim 1, wherein employing the statistical or numerical model comprises determining a potential association of one or more non-genetic factors and the S and D values with the one or more outcomes.

19. The method of claim 18, wherein the non-genetic factors are selected from the group consisting of clinical parameters, demographic data, environmental factors, and combinations thereof.

20. A system useful for performing genomic marker association studies wherein allelic contrast and copy number are analyzed simultaneously, comprising:
a receiving module for receiving, for each marker, one or more measurements of intensity for each of two alleles (A and B) for each sample in a biological sample set; and
a computing module for computing, for each marker, a sum value (S) and a difference value (D) of the intensities; and for employing, for each marker, a statistical or a numerical model to determine a potential association of the S and/or the D value with one or more outcomes of the biological sample set, wherein a statistically significant coefficient of the S intensity indicates an association of the copy number with the outcome and a statistically significant coefficient of the D intensity indicates an association of the allelic contrast with the outcome.

21. The system of claim 20, wherein the biological sample set comprises a binary outcome-type study, an ordinal outcome-type study, or a continuous outcome-type study.

22. The system of claim 21, wherein the biological sample set is selected from a group consisting of a case versus control study, a subject cell versus matched cell study, and a tumor cell versus normal cell study.

23. The system of claim 20, wherein the computing module comprises normalizing the measurements of intensity.

24. The system of claim 21, wherein the normalizing comprises normalizing the measurements of intensity to a reference distribution of measurements.

25. The system of claim 23, wherein the measurements are intensity measurements of oligonucleotide probe hybridization signals.

26. The system of claim 25, wherein the normalizing of the measurements is performed according to a method of quantile normalization, invariant set normalization, median centering normalization, or combinations thereof.

27. The system of claim 20, comprising creating a matrix for the S values and for the D values, wherein the S values for each biological sample for each marker are ordered to be the columns of the S matrix and the markers are ordered to be the rows of the S matrix, and wherein the D values for each biological sample for each marker are ordered to be the columns of the D matrix and the markers are ordered to be the rows of the D matrix.

28. The system of claim 27, comprising computing a singular value decomposition (SVD) for the S matrix and for the D matrix, wherein the SVD for the S matrix=U_{S} Σ_{S} V_{S}^{t} and the SVD for the D matrix=U_{D} Σ_{D} V_{D}^{t}, and wherein one or more diagonal values of the Σ_{D} and of the Σ_{S} that are associated with a dispersed nuisance effect are zeroed.

29. The system of claim 28, comprising computing a new sum value matrix (S′) and a new difference value matrix (D′), after the one or more diagonal values having dispersed effects are zeroed.

30. The system of claim 29, comprising filtering the D′ matrix rows and the S′ matrix rows that either exceed a predetermined level of variability or fall below a predetermined level of invariability.

31. The system of claim 20, wherein the statistical model is a model for binary, ordinal or continuous outcomes.

32. The system of claim 31, wherein the model for binary, ordinal or continuous outcomes is a general linear model.

33. The system of claim 32, wherein the general linear model is a logistic regression model.

34. The system of claim 33, wherein the logistic regression model is a model for binary outcomes.

35. The system of claim 20, wherein the statistical model is a multivariate model.

36. The system of claim 20, wherein the statistical significance of the coefficient is computed as a p-value.

37. The system of claim 20, wherein employing the statistical or the numerical model comprises determining a potential association of one or more non-genetic factors and the S and D values with the one or more outcomes.

38. The system of claim 37, wherein the non-genetic factors are selected from the group consisting of clinical parameters, demographic data, environmental factors, and combinations thereof.

39. A computer-readable medium having stored thereon computer executable instructions that when executed by a processor of a computer perform steps comprising:
receiving, for each marker, one or more measurements of intensity for each of two alleles (A and B) for each sample in a biological sample set;
computing, for each marker, a sum value (S) and a difference value (D) of the intensities; and
employing, for each marker, a statistical or a numerical model to determine a potential association of the S and/or the D value with one or more outcomes of the biological sample set, wherein a statistically significant coefficient of the S intensity indicates an association of the copy number with the outcome and a statistically significant coefficient of the D intensity indicates an association of the allelic contrast with the outcome.

40. The computer-readable medium of claim 39, wherein the biological sample set comprises a binary outcome-type study, an ordinal outcome-type study, or a continuous outcome-type study.

41. The computer-readable medium of claim 40, wherein the biological sample set is selected from a group consisting of a case versus control study, a subject cell versus matched cell study, and a tumor cell versus normal cell study.

42. The computer-readable medium of claim 39, comprising normalizing the measurements of intensity.

43. The computer-readable medium of claim 42, wherein the normalizing of each sample comprises normalizing the measurements of intensities to a reference distribution of measurements.

44. The computer-readable medium of claim 42, wherein the measurements are intensity measurements of oligonucleotide probe hybridization signals.

45. The computer-readable medium of claim 44, wherein the normalizing of the measurements is performed according to a method of quantile normalization, invariant set normalization, median centering normalization, or combinations thereof.

46. The computer-readable medium of claim 39, comprising creating a matrix for the S values and for the D values, wherein the S values for each biological sample for each marker are ordered to be the columns of the S matrix and the markers are ordered to be the rows of the S matrix, and wherein the D values for each biological sample for each marker are ordered to be the columns of the D matrix and the markers are ordered to be the rows of the D matrix.

47. The computer-readable medium of claim 46, comprising computing a singular value decomposition (SVD) for the S matrix and for the D matrix, wherein the SVD for the S matrix=U_{S} Σ_{S} V_{S}^{t} and the SVD for the D matrix=U_{D} Σ_{D} V_{D}^{t}, and wherein one or more diagonal values of the Σ_{D} and of the Σ_{S} that are associated with a dispersed nuisance effect are zeroed.

48. The computer-readable medium of claim 47, comprising computing a new sum value matrix (S′) and a new difference value matrix (D′), after the one or more diagonal values having dispersed effects are zeroed.

49. The computer-readable medium of claim 48, comprising filtering the D′ matrix rows and the S′ matrix rows that either exceed a predetermined level of variability or fall below a predetermined level of invariability.

50. The computer-readable medium of claim 39, wherein the statistical model is a model for binary, ordinal or continuous outcomes.

51. The computer-readable medium of claim 50, wherein the model for binary, ordinal or continuous outcomes is a general linear model.

52. The computer-readable medium of claim 51, wherein the general linear model is a logistic regression model.

53. The computer-readable medium of claim 52, wherein the logistic regression model is a model for binary outcomes.

54. The computer-readable medium of claim 39, wherein the statistical model is a multivariate model.

55. The computer-readable medium of claim 39, wherein the statistical significance of the coefficient is computed as a p-value.

56. The computer-readable medium of claim 39, wherein employing the statistical or the numerical model comprises determining a potential association of one or more non-genetic factors and the S and D values with the one or more outcomes.

57. The computer-readable medium of claim 56, wherein the non-genetic factors are selected from the group consisting of clinical parameters, demographic data, environmental factors, and combinations thereof.

58. The method of claim 18, further comprising employing:
a full statistical model which includes the genetic terms S and D and nongenetic terms; and
a reduced statistical model which only includes the nongenetic terms,
wherein a statistically significant result comparing the full statistical model with the reduced statistical model indicates an association of the genetic terms with the outcome.
